(19) United States
(12) Patent Application Publication
(10) Pub. No.: US 2026/0061732 A1
(43) Pub. Date: Mar. 5, 2026

(54) DECORATIVE ARTICLE AND METHOD OF MAKING SAME

(71) Applicant: Shaw Industries Group, Inc., Dalton, GA (US)

(72) Inventors: Bobby Wayne Leathers, Silver Creek, GA (US); Jay Peter Vecsey, Canton, GA (US); Mingchia Yang, Cartersville, GA (US); Roy Edward Reid, Cartersville, GA (US); Robert Lee Espitia, JR., Adairsville, GA (US); Jeff Wright, Cartersville, GA (US)

(21) Appl. No.: 19/138,077

(22) PCT Filed: Sep. 13, 2024
(86) PCT No.: PCT/US2024/046636

§ 371 Date: Jun. 11, 2025

Related U.S. Application Data
(60) Provisional application No. 63/582,829, filed on Sep. 14, 2023.

(51) Int. Cl. B32B 27/08; B32B 27/12; B32B 27/14; B32B 27/32

(52) U.S. Cl. CPC B32B 27/08; B32B 27/12; B32B 27/14; B32B 27/32; B32B 2262/0253; B32B 2262/0284; B32B 2270/00; B32B 2307/546; B32B 2307/584; B32B 2307/71; B32B 2307/718; B32B 2307/72; B32B 2307/734; B32B 2307/7375; B32B 2307/7376; B32B 2307/75; B32B 2451/00

(57) ABSTRACT

Described are decorative articles that includes a core layer having a top surface and an opposing bottom surface, wherein the decorative article has only one core layer being a single layer, wherein the core layer has a core composition that includes a first polyolefin and a filler; and a decorative portion having a top surface and an opposing bottom surface, wherein the top surface of the core layer is attached to the bottom surface of the decorative portion. Also described are methods of making the decorative articles.

### CROSS-REFERENCE TO RELATED APPLICATIONS

This application claims the benefit of the filing date of U.S. Provisional Patent Application Nos. 63/582,829, filed Sep. 14, 2023, the entirety of which is hereby incorporated by reference herein for all purposes.

### BACKGROUND

Decorative articles such as floor coverings, wall coverings, and ceiling panels are typically manufactured using polyvinyl chloride (PVC) used in resilient flooring, to construct a base, or core, layer of the composite. Currently, articles such as conventional resilient floorings utilize polyvinyl chloride plastisols, polyvinylchloride homopolymers, and polyvinylchloride acetate resin, as a primary component in the various core and other layers of the resilient flooring such as décor layer, wear layer, etc. There is a need for decorative articles made from other materials than PVC. Still further, there is a need for decorative articles having one or more of dimensional stability and flexibility as compared to existing decorative articles. These needs and other needs can be at least partially satisfied by one or more aspects of the present disclosure.

For example, the long term appearance of an installed decorative article is dependent on its dimensional stability which refers to the ability of the file or sheet to retain its original dimension and resist shrinkage over the usable service life of the flooring.

Articles prepared with PVC, such as resilient flooring tiles, are challenging to recycle on a global level. Due to different regional regulations, PVC articles cannot be recycled in their entirety because some components, such as DINP plasticizers, are outlawed in certain countries. The vast quantities of waste that are generated annually are burdensome to landfill capacity and have a negative impact on the environment. PVC must first be mechanically separated from the myriad of dissimilar polymeric and inorganic materials that are commonly present in these articles. Additionally, the cost of regrinding and re-compounding these resins are generally prohibitive when compared to the significantly lower cost of virgin vinyl resins.

There are also significant public health and safety concerns associated with the use of PVC systems. PVC products often comprise additional chemicals to change the chemical or physical properties of the product. For example, phthalate plasticizers have traditionally been added to make PVC systems more flexible. There are concerns that these additives can leach out of the vinyl products over time. Additionally, there are concerns that PVC-based flooring can over time release harmful chemical gases into the air. Some studies indicate that this outgassing may contribute to health complications. In view of these concerns, certain jurisdictions are now considering legislation that would ban the use of PVC in various consumer goods due to the threats it poses to human and environmental health.

### SUMMARY

In accordance with the purpose(s) of the invention as embodied and broadly described herein, the invention, in one aspect, relates to decorative articles having a core layer comprised of a composition comprising a first polyolefin.

Also disclosed herein is a decorative article comprising: a core layer having a top surface and an opposing bottom surface, wherein the decorative article comprises only one core layer being a single layer, wherein the core layer comprises a core composition comprising a first polyolefin and a filler; and a decorative portion having a top surface and an opposing bottom surface, wherein the top surface of the core layer is attached to the bottom surface of the decorative portion: wherein the decorative article has a flexibility-drape distance of from about 0.5″ to about 8″ as measured by a Drape Test at a testing length of 12″.

Also disclosed herein is a decorative article comprising: a balancing layer having a top surface and an opposing bottom surface; a core layer having a top surface and an opposing bottom surface, wherein the decorative article comprises only one core layer being a single layer, wherein the core layer comprises a core composition comprising a first polyolefin and a filler, wherein the top surface of the balancing layer is attached to the bottom surface of the core layer; and a decorative portion having a top surface and an opposing bottom surface, wherein the top surface of the core layer is attached to the bottom surface of the decorative portion; wherein the decorative article has a flexibility-drape distance of from about 0.5″ to about 8″ as measured by a Drape Test at a testing length of 12″.

Disclosed herein is a decorative article comprising: a core layer having atop surface and an opposing bottom surface, wherein the decorative article comprises only one core layer being a single layer, wherein the core layer comprises a core composition comprising a first polyolefin and a filler; and a decorative portion having a top surface and an opposing bottom surface, wherein the top surface of the core layer is attached to the bottom surface of the decorative portion; wherein the decorative article is characterized in that the decorative article passes a Mandrel bend radius test as measured according to ASTM F137.

Also disclosed herein is a decorative article comprising: a core layer having a top surface and an opposing bottom surface, wherein the decorative article comprises only one core layer being a single layer, wherein the core layer comprises a core composition comprising a first polyolefin and a filler; and a decorative portion having a top surface and an opposing bottom surface, wherein the top surface of the core layer is attached to the bottom surface of the decorative portion; wherein the decorative article has a maximum variation in width and a maximum variation in length of no more than about 2.0 mm when heated to a temperature of about 176° F. as measured according to ISO 23999.

Also disclosed herein is a decorative article comprising: a core layer having a top surface and an opposing bottom surface, wherein the decorative article comprises only one core layer being a single layer, wherein the core layer comprises a core composition comprising a first polyolefin and a filler; and a decorative portion having a top surface and an opposing bottom surface, wherein the top surface of the core layer is attached to the bottom surface of the decorative portion; wherein the curl of the decorative article as measured according to BS EN ISO 23999 is less than about 0.5 mm.

Also disclosed herein is a decorative article comprising: a balancing layer having a top surface and an opposing bottom surface; a core layer having a top surface and an opposing bottom surface, wherein the decorative article comprises only one core layer being a single layer, wherein the core layer comprises a core composition comprising a first polyolefin and a filler, wherein the top surface of the balancing layer is attached to the bottom surface of the core layer; and a decorative portion having a top surface and an opposing bottom surface, wherein the top surface of the core layer is attached to the bottom surface of the decorative portion; wherein the decorative article is characterized in that the decorative article passes a Mandrel bend radius test as measured according to ASTM F137.

Also disclosed herein is a decorative article comprising: a balancing layer having a top surface and an opposing bottom surface; a core layer having a top surface and an opposing bottom surface, wherein the decorative article comprises only one core layer being a single layer, wherein the core layer comprises a core composition comprising a first polyolefin and a filler, wherein the top surface of the balancing layer is attached to the bottom surface of the core layer; and a decorative portion having a top surface and an opposing bottom surface, wherein the top surface of the core layer is attached to the bottom surface of the decorative portion; wherein the dimensional stability of the decorative article as measured according to ISO23999 is characterized to have a maximum variation in width and a maximum variation in length of no more than about 2.0 mm when heated to a temperature of about 176° F.

Also disclosed herein is a decorative article comprising: a balancing layer having a top surface and an opposing bottom surface; a core layer having a top surface and an opposing bottom surface, wherein the decorative article comprises only one core layer being a single layer, wherein the core layer comprises a core composition comprising a first polyolefin and a filler, wherein the top surface of the balancing layer is attached to the bottom surface of the core layer; and a decorative portion having a top surface and an opposing bottom surface, wherein the top surface of the core layer is attached to the bottom surface of the decorative portion; wherein the curl of the decorative article as measured according to BS EN ISO 23999 is less than about 0.5 mm.

Also disclosed herein is a decorative article comprising: a core layer having a top surface and an opposing bottom surface, wherein the decorative article comprises only one core layer being a single layer, wherein the core layer comprises a core composition comprising a first polyolefin and a filler; and a decorative portion having a top surface and an opposing bottom surface, wherein the top surface of the core layer is attached to the bottom surface of the decorative portion; wherein the first polyolefin is an elastomer of propylene and ethylene derived units.

Also disclosed herein is a decorative article comprising: a balancing layer having a top surface and an opposing bottom surface; a core layer having a top surface and an opposing bottom surface, wherein the decorative article comprises only one core layer being a single layer, wherein the core layer comprises a core composition comprising a first polyolefin and a filler, wherein the top surface of the balancing layer is attached to the bottom surface of the core layer; and a decorative portion having a top surface and an opposing bottom surface, wherein the top surface of the core layer is attached to the bottom surface of the decorative portion: wherein the first polyolefin is an elastomer of propylene and ethylene derived units.

Also disclosed herein is a method of making a decorative article comprising: a) providing a core layer from a core composition comprising a first polyolefin and a filler, wherein the formed core layer has a top surface and an opposing bottom surface, wherein the first polyolefin is an elastomer of propylene and ethylene derived units; and b) attaching a decorative portion having a top surface and an opposing bottom surface to the top surface of the core layer.

Additional aspects of the invention will be set forth, in part, in the detailed description, and claims that follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF DRAWINGS

FIG. 1. is a schematic side view illustration of an exemplary decorative article as disclosed and described herein.

FIG. 2 is a schematic side view illustration of an exemplary decorative article as disclosed and described herein.

FIG. 3 is a schematic side view illustration of an exemplary decorative article as disclosed and described herein.

FIG. 4 is a schematic side view illustration of an exemplary decorative article as disclosed and described herein.

FIG. 5 is a schematic illustrating a Drape Test performed on representative decorative articles as disclosed and described herein.

### DETAILED DESCRIPTION

The present invention can be understood more readily by reference to the following detailed description, examples, drawings, and claims, and their previous and following description. However, before the present articles, systems, and/or methods are disclosed and described in further detail, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

As used herein, the singular forms “a,” “an” and “the” include plural referents unless the context clearly dictates otherwise. Thus, for example, reference to a “fiber” includes aspects having two or more such fibers unless the context clearly indicates otherwise.

As used herein, the term “comprising” can include the aspects “consisting of” and “consisting essentially of.” The term “comprising” can also mean “including but not limited to.”

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It should be further understood that the endpoints of each of the ranges are significant both in relation to the other endpoint, and independently of the other endpoint. Moreover, in still further aspects, reference to a parameter that equals a particular endpoint or specific value also includes aspects that are characterized as being greater than the stated value or, alternatively, less than the stated value.

As used herein, the term “attached” when referring to layers and/or portions being attached to each other means that they are connected but it does not mean that they are necessarily directly attached to each other. Thus, if two layers are attached to each other this means that there could be one or more additional layers sandwiched between the two layers. For example. “a top surface of a core layer attached to a bottom surface of a decorative portion” includes the possibility of one or more layers and/or portions being present between the top surface of the core layer and the bottom surface of the decorative portion.

As used herein, the terms “optional” or “optionally” mean that the subsequently described event or circumstance may or may not occur, and that the description includes instances where said event or circumstance occurs and instances where it does not.

As used herein, the term “tile” refers to any modular tile, including, for example and without limitation, resilient flooring tiles or wall tiles.

References in the specification and concluding claims to parts by weight of a particular element or component in a composition or article, denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5, and are present in such ratio regardless of whether additional components are contained in the composition.

A weight percent of a component, unless specifically stated to the contrary, is based on the total weight of the formulation or composition in which the component is included.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Articles

Disclosed herein are decorative articles, such as composite decorative articles. In certain aspects, the disclosed decorative articles can be in flooring, wall, ceiling, or furniture constructions. For example, the decorative article can be a floor or wall covering. The floor covering can be a tile or plank.

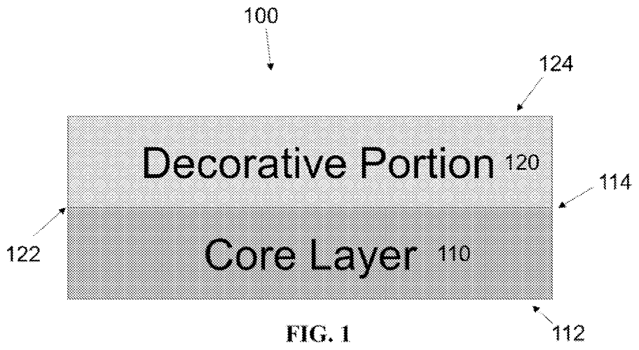

In a further aspect, and as generally depicted in FIG. 1, the decorative article 100 generally comprise a core layer 110 having a top surface 114 and an opposing bottom surface 112 and a decorative portion 120 having atop surface 124 and an opposing bottom surface 122. In one aspect, the decorative article described herein can comprise a core layer having a top surface and an opposing bottom surface. In a further aspect, the decorative article comprises only one core layer being a single layer. In a yet further aspect, the core layer comprises a core composition comprising a first polyolefin and a filler. In a still further aspect, the first polyolefin is an elastomer of propylene and ethylene derived units.

In another aspect, the decorative article described herein can comprise a decorative portion having a top surface and an opposing bottom surface. In a further aspect, the top surface of the core layer is attached to the bottom surface of the decorative portion. For example, the top surface of the core layer can be directly laminated using heat and pressure to the bottom surface of the decorative portion. In another example, the top surface of the core layer can be attached to the bottom surface of the decorative portion via a tie layer.

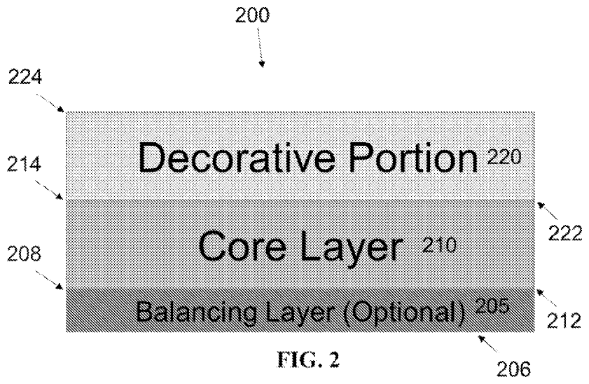

In some aspects, the decorative article can further comprise a balancing layer having a top surface and an opposing bottom surface. As generally depicted in FIG. 2, the decorative article 200 disclosed herein can comprise a core layer 210 having a top surface 214 and an opposing bottom surface 212, a decorative portion 220 having a top surface 224 and an opposing bottom surface 222, and an balancing layer 205 having a top surface 208 and an opposing bottom surface 206, wherein the top surface 208 of the balancing layer 205 is attached to the bottom surface 212 of the core layer 210 and the top surface 214 of the core layer 210 is attached to the bottom surface 222 of the decorative portion 220. In one aspect, the balancing layer 205 is present in the decorative article.

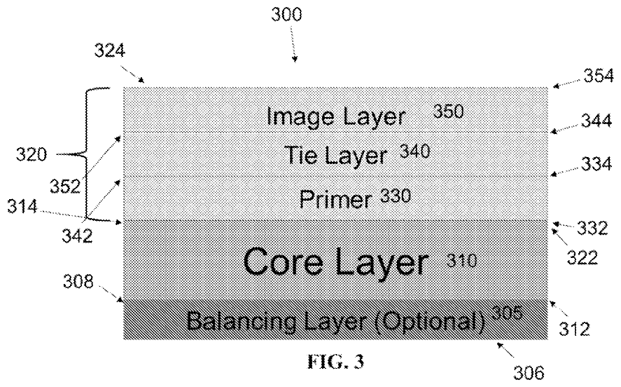

In various aspects, the decorative portion can comprise a primer. In certain aspects, the decorative portion comprises an image layer. In some aspects, the decorative portion can comprise a tie layer. In a further aspect, the image layer can comprise a printed film layer. In a yet further aspect, the printed film layer can comprise a substrate layer and an ink layer. As generally depicted in FIG. 3, the decorative article 300 disclosed herein can comprise an optional balancing layer 305 having a top surface 308 and an opposing bottom surface 306, a core layer 310 having a top surface 314 and an opposing bottom surface 312, and a decorative portion 320 comprising a primer 330 having a top surface 334 and an opposing bottom surface 332, a tie layer 340 having a top surface 344 and an opposing bottom surface 342, and an image layer 350 having a top surface 354 and an opposing bottom surface 352, wherein the decorative portion has a top surface 324 and an opposing bottom surface 322.

As shown in FIG. 3, the top surface 308 of the balancing layer 305 is attached to the bottom surface 312 of the core layer 310 and the top surface 314 of the core layer 310 is attached to the opposing bottom surface 322 of the decorative portion 320, being the bottom surface 332 of the primer 330, the top surface 334 of the primer 330 is attached to the opposing bottom surface 342 of the tie layer 340, the top surface 344 of the tie layer 340 is attached to the opposing bottom surface 352 of the image layer 350.

In some aspects, the decorative article comprises a scratch layer. In a further aspect, the decorative article comprises a top layer. In a yet further aspect, the top layer is a scratch layer.

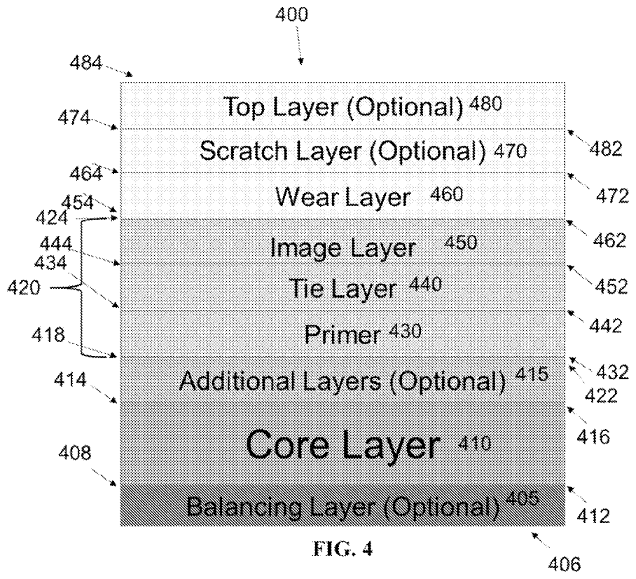

In some aspects, the decorative article can comprise additional layers. The decorative article can comprise, for example, at least one of an acoustic layer, a scrim layer, or a fiberglass layer. As generally depicted in FIG. 4, the decorative article 400 disclosed herein can comprise an optional balancing layer 405 having a top surface 408 and an opposing bottom surface 406, a core layer 410 having a top surface 414 and an opposing bottom surface 412, optional additional layer(s) 415 having a top surface 418 and an opposing bottom surface 416, a decorative portion 420 having a top surface 424 and an opposing bottom surface 422 comprising a primer 430 having a top surface 434 and an opposing bottom surface 432, a tie layer 440 having a top surface 444 and an opposing bottom surface 442, an image layer having a top surface 453 and an opposing bottom surface 452, a tie layer 455 having a top surface 456 and an opposing bottom surface 454, a wear layer 460 having a top surface 464 and an opposing bottom surface 462, an optional scratch layer 470 having a top surface 474 and an opposing bottom surface 472, and an optional top layer 480 having a top surface 484 and an opposing bottom surface 482. In various aspects, the decorative article passes a Mandrel bend radius test as measured according to ASTM F137. The test is considered as passed if no cracks or breaks are observed when the sample of the decorative article is bend around a 1″ mandrel. In yet other aspects, the decorative article passes a Mandrel bend radius test of less than 1 inch measured according to ASTM F137.

Dimensional stability according to the ISO 23999 Heat Curl Dimensional Stability standards can be measured by analyzing the decorative article's variations in width and length when the article is heated to a temperature of about 176° F. and then cooled back to ambient temperature. In some aspects, the decorative article has a maximum variation in width and a maximum variation in length of no more than about 2.0 mm when heated to a temperature of about 176° F. as measured according to ISO 23999. In some aspects, the decorative article can have a maximum variation in width and a maximum variation in length of no more than about, for example, 0.5 mm, 1.0 mm, 1.5 mm, or about 1.75 mm when heated to a temperature of about 176° F. as measured according to ISO 2399.

In some aspects, the decorative article has a maximum variation in width and a maximum variation in length of no more than about 0.167% when heated to a temperature of about 176° F. as measured according to ISO 23999. For example, the decorative article has a maximum variation in width and a maximum variation in length of no more than about 0.15%, 0.12%, 0.10%, or 0.08% when heated to a temperature of about 176° F. as measured according to ISO 23999.

Curl according to BS EN ISO 23999 can be measured by analyzing the vertical deformation of the decorative article when the article is heated to a temperature of about 176° F. and then cooled back to ambient temperature. In some aspects, the decorative article is characterized in that a curl of the decorative article as measured according to BS EN ISO 23999 is less than about 0.5 mm.

For example, the decorative article is characterized in that the decorative article passes a Mandrel bend radius test as measured according to ASTM F137 and has a maximum variation in width and a maximum variation in length of no more than about 2.0 mm when heated to a temperature of about 176° F. as measured according to ISO 23999. In another example, the decorative article is characterized in that the decorative article passes a Mandrel bend radius test as measured according to ASTM F137, has a maximum variation in width and a maximum variation in length of no more than about 2.0 mm when heated to a temperature of about 176° F. as measured according to ISO 23999, and is characterized in that a curl of the decorative article as measured according to BS EN ISO 23999 is less than about 0.5 mm. In another example, the decorative article is characterized in that the decorative article passes a Mandrel bend radius test as measured according to ASTM F137, and is characterized in that a curl of the decorative article as measured according to BS EN ISO 23999 is less than about 0.5 mm. In another example, the decorative article passes a Mandrel bend radius test as measured according to ASTM F137, has a maximum variation in width and a maximum variation in length of no more than about 2.0 mm when heated to a temperature of about 176° F. as measured according to ISO 23999, and is characterized in that a curl of the decorative article as measured according to BS EN ISO 23999 is less than about 0.5 mm.

In some aspects, the core layer comprising the core composition and the balancing layer comprise the same type of polymer, such as, for example, polypropylene. In a further aspect, the core layer comprising the core composition and the balancing layer comprise the same type of polymer being a polypropylene polymer.

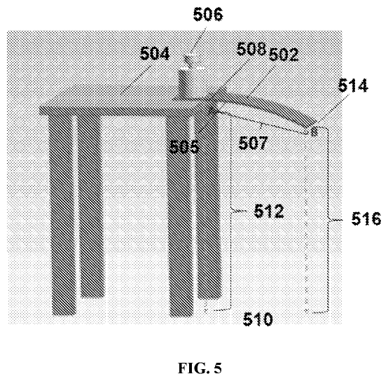

In some aspects, the decorative article disclosed herein, such as a decorative article comprising a core layer, a decorative portion, and a balancing layer; or a decorative article comprising a core layer and a decorative portion, has a flexibility-drape distance of from about 0.5″ and 8″ as measured by a Drape Test at a testing length of 12″. The flexibility-drape distance is measured by a Drape Test as illustrated in FIG. 5. The flexibility-drape distance of the core layer is determinative of the flexibility-drape distance of the decorative article. As such, the flexibility-drape distance of the core layer corresponds to the flexibility-drape distance of the decorative article. The decorative article/core layer 502 is placed on the edge 508 of an elevated surface 504 and clamped in place with a clamp 506 such that a portion of the length (the testing length 507), for example 6″, 9″, 12″, 15″, 18″, or 21″ of the decorative article is not directly supported by the elevated surface 504. For example, a testing length 507 of 12″ means that 12″ of the decorative article 502 overhangs the edge 508 of an elevated surface 504, which is measured from the edge 508 of the elevated surface 504 to an end 514 of the decorative article 502. The decorative article 502 bends over the testing length 507 as shown FIG. 5. The less the bend of the decorative article 502 the stiffer the decorative article 502. The more the bend of the decorative article 502 the more flexible the decorative article 502. The distance between the underside 505 of the decorative article 502 at the edge 508 of the elevated surface 504 and the ground 510 is measured to give a distance 512. This is followed by measuring the distance between the underside 505 of the decorative article 502 at an end 514 of the decorative article 502 and the ground 510 to give a distance 516. The difference between distance 512 and distance 516 yields the flexibility-drape distance. The decorative article disclosed herein, such as a decorative article comprising a core layer, a decorative portion, and a balancing layer; or a decorative article comprising a core layer and a decorative portion, can have a flexibility drape-distance of, for example, from about 0.5″ to 7″, about 0.5″ to 6″, about 0.5″ to 5″, about 0.5″ to 4″, about 0.5″ to 3″, about 0.5″ to 2″, about 1″ to 8″, about 1″ to 7″, about 1″ to 6″, about 1″ to 5″, about 1″ to 4″, about 1″ to 3″, about 1″ to 2″, about 2″ to 8″, about 2″ to 7″, about 2″ to 6″, about 2″ to 5″, about 2″ to 4″, about 2″ to 3″, about 3″ to 8″, about 3″ to 7″, about 3″ to 6″, about 3″ to 5″, about 3″ to 4″, about 4″ to 8″, about 4″ to 7″, about 4″ to 6″, about 4″ to 5″, about 5″ to 8″, about 5″ to 7″ about 5″ to 6″, about 6″ to 8″, about 6″ to 7″, or about 7″ to 8″ at a testing length of 12″. The decorative article disclosed herein, such as a decorative article comprising a core layer, a decorative portion, and a balancing layer or a decorative article comprising a core layer and a decorative portion, can have a flexibility-drape distance of, for example, about 0.5″, 1″, 2.5″, 3″, 3.5″, 4″, 4.5″, 5″, 5.5″, 6″, 6.5″, 7″, 7.5″, or about 8″ at a testing length of 12″.

In one aspect, the decorative article disclosed herein does not comprise a vinyl polymer, such as PVC. As such, in such aspects, the core layer, the decorative portion, and, in present, the balancing layer does not comprise a vinyl polymer, such as PVC.

### 1. Core Layer

In one aspect, the core layer of the decorative article can have a top surface and an opposing bottom surface. In a further aspect, the decorative article comprises only one core layer being a single layer. In a yet further aspect, the decorative article does not comprise more than one core layer. Without being bound by any theory, it is contemplated that the core composition of the core layer provides a core layer with desired properties, such as a desired flexibility-drape distance as measured by a Drape Test, and/or a maximum variation in width and a maximum variation in length of no more than about 0.167% when heated to a temperature of about 176° F. as measured according to ISO 23999, and/or a curl of the decorative article as measured according to BS EN ISO 23999 is less than about 0.5 mm. The flexibility-drape distance of the core layer as measured by a Drape Test defines the flexibility-drape distance of the decorative article. In some aspects, the flexibility-drape distance of the core layer as measured by a Drape Test is the flexibility-drape distance of the decorative article.

The core layer comprises a core composition comprising a first polyolefin and a filler. As defined herein, the term “polyolefin” refers to any class of polymers produced from a simple olefin (also called an alkene with the general formula CH₂˜) as a monomer. In some aspects, first polyolefins which can be used to produce the core layer include, but are not limited to, polyolefins comprising polyethylene, polypropylene, both homopolymer and copolymers, poly(l-butene), poly(3-methyl-1-butene), poly(4-methyl-1-pentene) and the like, as well as combinations or mixtures of two or more of the foregoing. The first polyolefin provides increased flexibility in the core layer. The first polyolefin does not crystallize the core composition. The first polyolefin can be a copolymer or a homopolymer. In some aspects, the first polyolefin is a homopolymer. In a further aspect, the first polyolefin is a copolymer. In a further aspect, the first polyolefin is an elastomer of propylene and ethylene derived units. In a yet further aspect, the first polyolefin is a polypropylene elastomer comprising from greater than 10 to 15 weight percent ethylene derived units based upon the weight of the polypropylene elastomer. In yet another aspect, the first polyolefin is a polypropylene elastomer comprising from greater than 12 to 14 weight percent ethylene derived units based upon the weight of the polypropylene elastomer. In a still further aspect, the first polyolefin is a polypropylene elastomer comprising about 13 weight percent ethylene derived units based upon the weight of the polypropylene elastomer. A commercial example of a first polyolefin is VISTAMAXX™ 6502, which is manufactured by ExxonMobil Chemical Company.

In some aspects, the first polyolefin has a melt mass-flow rate from about 20 g/10 min to about 60 g/10 min at 230° C./2.16 kg as measured by ASTM D1238, including exemplary values of about 20 g/10 min at 230° C./2.16 kg, about 30 g/10 min at 230° C./2.16 kg, about 35 g/10 min at 230° C./2.16 kg, about 40 g/10 min at 230° C./2.16 kg, about 45 g/10 min at 230° C./2.16 kg, about 50 g/10 min at 230° C./2.16 kg, and about 55 g/10 min at 230° C./2.16 kg. In further aspects, the first polyolefin has a melt mass-flow rate of at least about 20 g/10 min at 230° C./2.16 kg, at least about 20 g/10 min at 230° C./2.16 kg, at least about 30 g/10 min at 230° C./2.16 kg, at least about 35 g/10 min at 230° C./2.16 kg, at least about 40 g/10 min at 230° C./2.16 kg, at least about 45 g/10 min at 230° C./2.16 kg, at least about 50 g/10 min at 230° C./2.16 kg, and at least about 55 g/10 min at 230° C./2.16 kg. In yet further aspects, the first polyolefin has a melt mass-flow rate of at most about 60 g/10 min at 230° C./2.16 kg. In still further aspects, the first polyolefin has a mass melt flow-rate in a range derived from any two of the above listed exemplary mass melt flow-rate values. For example, the first polyolefin can have a mass melt flow-rate in a range of from about 20 g/10 min to about 55 g/10 min at 230° C./2.16 kg, about 30 g/10 min to about 55 g/10 min at 230° C./2.16 kg, from about 35 g/10 min to about 50 g/10 min at 230° C./2.16 kg, and from about 40 g/10 min to about 50 g/10 min at 230° C./2.16 kg. In one aspect, the first polyolefin has a melt mass-flow rate of about 45 g/10 min at 230° C./2.16 kg.

In various aspects, the core composition can comprise a first polyolefin in an amount of from about 5% to about 50% by weight, including exemplary first polyolefin weight % values of about 5% by weight, about 10% by weight, about 15% by weight, about 20% by weight, about 25% by weight, about 30% by weight, about 35% by weight, about 40% by weight, about 45% by weight, and about 50% by weight. In further aspects, the core composition can comprise a first polyolefin in an amount of at least about 5% by weight, at least about 10% by weight, at least about 15% by weight, at least about 20% by weight, at least about 25% by weight, at least about 30% by weight, at least about 35% by weight, at least about 40% by weight, or at least about 45% by weight. In yet further aspects, the core composition can comprise a first polyolefin in an amount of at most about 50% by weight. In yet further aspects, the core composition can comprise a first polyolefin in an amount of at least 5% by weight to at most about 50% by weight. In still further aspects, the core composition can comprise a first polyolefin in a range derived from any two of the above listed exemplary weight percentage values. For example, the core composition can comprise a first polyolefin in a range of from about 10% to about 40% by weight, from about 10% to about 30% by weight, from about 5% to about 40% by weight, or from about 5% to about 30% by weight. In a further aspect, the core composition comprises a first polyolefin in an amount of from about 10% to about 30% by weight. In a further aspect, the core composition comprises a first polyolefin being an elastomer of propylene and ethylene derived units in an amount of from about 10% to about 30% by weight.

In some aspects, the core composition comprises a non-woven material comprising polypropylene, a non-woven material comprising polyethylene terephthalate, a point bond material comprising polypropylene, a point bond material comprising polyethylene terephthalate, a film comprising polypropylene, a film comprising polyethylene, or UV lacquer. In a further aspect, the balancing layer comprises a UV lacquer. In a yet further aspect, the UV lacquer is acrylic resin.

The core composition comprises a filler in addition to the first polyolefin. Exemplary fillers can include, for example and without limitation, calcium carbonate, fly-ash, recycled calcium carbonate, aluminum trihydrate, talc, nano-clay, barium sulfate, barite, barite glass fiber, glass powder, glass cullet, metal powder, alumina, hydrated alumina, clay, magnesium carbonate, calcium sulfate, silica, glass, fumed silica, carbon black, graphite, cement dust, feldspar, nepheline, magnesium oxide, zinc oxide, aluminum silicate, calcium silicate, titanium dioxide, titanates, glass microspheres, chalk, calcium oxide, or any combination thereof. In a yet further aspect, the filler comprises calcium carbonate.

In a further aspect, the core composition can comprise the filler in an amount of from about 40% to about 95% percent by weight of the core composition, including exemplary values filler values of about 50% by weight, about 60% by weight, about 70% by weight, about 80% by weight, and about 90% by weight. In still further aspects, the core composition can comprise the filler in an amount of at least about 50% by weight, at least about 60% by weight, at least about 70% by weight, at least about 80% by weight, or at least about 90% by weight. In still further aspects, the core composition can comprise the filler in an amount of at most about 95% by weight. In still further aspects, the core composition can comprise a filler in a range derived from any two of the above listed exemplary weight percentage values. For example, the core composition can comprise a filler in a range of from about 45% to about 90% by weight, from about 60% to about 90% by weight, from about 45% to about 95% by weight, or from about 60% to about 95% by weight. In a further aspect, the core composition comprises a filler in an amount of from about 45% to about 95% by weight. In a still further aspect, the core composition comprises a filler being calcium carbonate in an amount of from about 45% to about 95% by weight. In a yet still further aspect, the core composition comprises a filler being calcium carbonate in an amount of about 710% by weight.

In various aspects, the core composition can further comprise a stiffening polyolefin. The stiffening polyolefin is different from the first polyolefin. The stiffening polyolefin can be included in the core composition to make the core layer and decorative article have improved dimensional stability and/or flexibility. When combined with the first polyolefin in the core composition, the stiffening polyolefin can crystallize the core composition and set it, providing increased stiffening properties that stabilize the core layer and decorative article. Thus, the flexibility and dimensional stability of the core layer and decorative article can be adjusted by increasing or decreasing the ratio between the first polyolefin and the stiffening polyolefin. The flexibility-drape distance of the core layer and decorative article, for example, decreases by decreasing the ratio between the first polyolefin and the stiffening polyolefin.

In some aspects, stiffening polyolefins which can be included in the core composition used to produce the core layer include, but are not limited to, polyolefins comprising polyethylene, polypropylene, both homopolymer and copolymers, poly(1-butene), poly(3-methyl-l-butene), poly(4-methyl-1-pentene) and the like, as well as combinations or mixtures of two or more of the foregoing. The stiffening polyolefin can be a copolymer or a homopolymer. In some aspects, the stiffening polyolefin is a homopolymer. In a further aspect, the stiffening polyolefin is a copolymer. In a further aspect, the stiffening polyolefin comprises polypropylene. A commercial example of a stiffening polyolefin is PP1024E4, which is manufactured by ExxonMobil Chemical Company.

In some aspects, the stiffening polyolefin has a melt mass-flow rate from about 10 g/10 min to about 18 g/10 min at 230° C./2.16 kg as determined by ASTM D1238, including exemplary values of about 11 g/10 min at 230° C./2.16 kg, about 12 g/10 min at 230° C./2.16 kg, about 13 g/10 min at 230° C./2.16 kg, about 14 g/10 min at 230° C./2.16 kg, about 15 g/10 min at 230° C./2.16 kg, about 16 g/10 min at 230° C./2.16 kg, and about 17 g/10 min at 230° C./2.16 kg. In further aspects, the stiffening polyolefin has a melt mass-flow rate of at least about 11 g/10 min at 230° C./2.16 kg, at least about 12 g/10 min at 230° C./2.16 kg, at least about 13 g/10 min at 230° C./2.16 kg, at least about 14 g/10 min at 230° C./2.16 kg, at least about 15 g/10 min at 230° C./2.16 kg, at least about 16 g/10 min at 230° C./2.16 kg, and at least about 17 g/10 min at 230° C./2.16 kg. In yet further aspects, the stiffening polyolefin has a melt mass-flow rate of at most about 18 g/10 min at 230° C./2.16 kg. In still further aspects, the stiffening polyolefin has a mass melt flow-rate in a range derived from any two of the above listed exemplary mass melt flow-rate values. For example, the stiffening polyolefin can have a mass melt flow-rate in a range of from about 10 g/10 min to about 15 g/10 min at 230° C./2.16 kg, from about 12 g/10 min to about 17 g/10 min at 230° C./2.16 kg, and from about 12 g/10 min to about 14 g/10 min at 230° C./2.16 kg. In one aspect, the stiffening polyolefin has a melt mass-flow rate of about 13 g/10 min at 230° C./2.16 kg.

In a further aspect, the core composition can comprise the stiffening polyolefin in an amount of from greater than 0% to about 15% percent by weight of the core composition, including exemplary filler values of about 0.5% by weight, about 10% by weight, about 5% by weight, about 10% by weight, and about 15% by weight. In further aspects, the core composition can comprise the stiffening polyolefin in an amount of at least about 0.5% by weight, at least about 1% by weight, at least about 5% by weight, at least about 10% by weight, and at least about 14% by weight. In yet further aspects, the core composition can comprise the stiffening polyolefin in an amount of at most about 15% by weight. In still further aspects, the core composition can comprise a stiffening polyolefin in a range derived from any two of the above listed exemplary weight percentage values. For example, the core composition can comprise a stiffening polyolefin in a range of from about 0.5% to about 15% by weight, from about 0.5% to about 10% by weight, from greater than 0% to about 10% by weight, or from greater than 0% to about 5% by weight. In a further aspect, the core composition comprises a stiffening polyolefin in an amount of from about 0.5% to about 15% by weight.

In some aspects, the core composition can comprise the first polyolefin in an amount of from about 5% to about 50% by weight of the core composition and the stiffening polyolefin in an amount of from greater than 0% to about 15% by weight of the core composition.

In various aspects, the core composition can comprise the first polyolefin in an amount of from about 5% to about 50% by weight of the core composition and the stiffening polyolefin in an amount of from greater than 0% to about 12% by weight of the core composition. In a further aspect, the core composition can comprise the first polyolefin in an amount of from about 5% to about 50% by weight of the core composition and the stiffening polyolefin in an amount of from greater than 0% to about 10% by weight of the core composition. In a further aspect, the core composition can comprise the first polyolefin in an amount of from about 5% to about 50% by weight of the core composition and the stiffening polyolefin in an amount of from greater than 0% to about 7% by weight of the core composition. In a further aspect, the core composition can comprise the first polyolefin in an amount of from about 5% to about 50% by weight of the core composition and the stiffening polyolefin in an amount of from greater than 0% to about 5% by weight of the core composition. In a further aspect, the core composition can comprise the first polyolefin in an amount of from about 5% to about 50% by weight of the core composition and the stiffening polyolefin in an amount of from greater than 0% to about 2% by weight of the core composition. In a further aspect, the core composition can comprise the first polyolefin in an amount of from about 5% to about 50% by weight of the core composition and the stiffening polyolefin in an amount of from about 2% to about 15% by weight of the core composition. In a further aspect, the core composition can comprise the first polyolefin in an amount of from about 5% to about 50% by weight of the core composition and the stiffening polyolefin in an amount of from about 5% to about 15% by weight of the core composition. In a further aspect, the core composition can comprise the first polyolefin in an amount of from about 5% to about 50% by weight of the core composition and the stiffening polyolefin in an amount of from about 5% to about 15% by weight of the core composition. In a further aspect, the core composition can comprise the first polyolefin in an amount of from about 5% to about 50% by weight of the core composition and the stiffening polyolefin in an amount of from about 7% to about 15% by weight of the core composition. In a further aspect, the core composition can comprise the first polyolefin in an amount of from about 5% to about 50% by weight of the core composition and the stiffening polyolefin in an amount of from about 10% to about 15% by weight of the core composition. In a further aspect, the core composition can comprise the first polyolefin in an amount of from about 5% to about 50% by weight of the core composition and the stiffening polyolefin in an amount of from about 12% to about 15% by weight of the core composition.

In some aspects, the core composition can comprise the first polyolefin in an amount of from about 10% to about 50% by weight of the core composition and the stiffening polyolefin in an amount of from greater than 0% to about 15% by weight of the core composition. In a further aspect, the core composition can comprise the first polyolefin in an amount of from about 15% to about 50% by weight of the core composition and the stiffening polyolefin in an amount of from greater than 0% to about 15% by weight of the core composition. In a further aspect, the core composition can comprise the first polyolefin in an amount of from about 20% to about 50% by weight of the core composition and the stiffening polyolefin in an amount of from greater than 0% to about 15% by weight of the core composition. In a further aspect, the core composition can comprise the first polyolefin in an amount of from about 25% to about 50% by weight of the core composition and the stiffening polyolefin in an amount of from greater than 0% to about 15% by weight of the core composition. In a further aspect, the core composition can comprise the first polyolefin in an amount of from about 30% to about 50% by weight of the core composition and the stiffening polyolefin in an amount of from greater than 0% to about 15% by weight of the core composition. In a further aspect, the core composition can comprise the first polyolefin in an amount of from about 35% to about 50% by weight of the core composition and the stiffening polyolefin in an amount of from greater than 0% to about 15% by weight of the core composition. In a further aspect, the core composition can comprise the first polyolefin in an amount of from about 40% to about 50% by weight of the core composition and the stiffening polyolefin in an amount of from greater than 0% to about 15% by weight of the core composition. In a further aspect, the core composition can comprise the first polyolefin in an amount of from about 45% to about 50% by weight of the core composition and the stiffening polyolefin in an amount of from greater than 0% to about 15% by weight of the core composition. In a further aspect, the core composition can comprise the first polyolefin in an amount of from about 5% to about 45% by weight of the core composition and the stiffening polyolefin in an amount of from greater than 0% to about 15% by weight of the core composition. In a further aspect, the core composition can comprise the first polyolefin in an amount of from about 5% to about 40% by weight of the core composition and the stiffening polyolefin in an amount of from greater than 0% to about 15% by weight of the core composition. In a further aspect, the core composition can comprise the first polyolefin in an amount of from about 5% to about 35% by weight of the core composition and the stiffening polyolefin in an amount of from greater than 0% to about 15% by weight of the core composition. In a further aspect, the core composition can comprise the first polyolefin in an amount of from about 5% to about 30% by weight of the core composition and the stiffening polyolefin in an amount of from greater than 0% to about 15% by weight of the core composition. In a further aspect, the core composition can comprise the first polyolefin in an amount of from about 5% to about 25% by weight of the core composition and the stiffening polyolefin in an amount of from greater than 0% to about 15% by weight of the core composition. In a further aspect, the core composition can comprise the first polyolefin in an amount of from about 5% to about 20% by weight of the core composition and the stiffening polyolefin in an amount of from greater than 0% to about 15% by weight of the core composition. In a further aspect, the core composition can comprise the first polyolefin in an amount of from about 5% to about 15% by weight of the core composition and the stiffening polyolefin in an amount of from greater than 0% to about 15% by weight of the core composition.

In some aspects, the core composition can comprise the first polyolefin in an amount of from about 10% to about 45% by weight of the core composition and the stiffening polyolefin in an amount of from greater than 0% to about 10% by weight of the core composition. In a further aspect, the core composition can comprise the first polyolefin in an amount of from about 5% to about 40% by weight of the core composition and the stiffening polyolefin in an amount of from greater than 0% to about 5% by weight of the core composition. In a further aspect, the core composition can comprise the first polyolefin in an amount of from about 15% to about 40% by weight of the core composition and the stiffening polyolefin in an amount of from about 1% to about 5% by weight of the core composition.

In some aspects, the core composition can comprise a weight/weight ratio of the first polyolefin:stiffening polyolefin of from about 2:1 to about 30:1, including exemplary ratios of first polyolefin:stiffening polyolefin of about 2:1, 4:1, 5:1, 7:1, 10:1, 15:1, 20:1, 25:1, and about 30:1. In further aspects, the core composition can comprise a weight/weight ratio of the first polyolefin:stiffening polyolefin of from about 2:1 to 25:1, 2:1 to 20:1, 2:1 to 15:1.2:1 to 7:1, 2:1 to 4:1.4:1 to 30:1, 4:1 to 25:1, 4:1 to 20:1, 4:1 to 15:1, 4:1 to 7:1, 7:1 to 30:1, 7:1 to 25:1, 7:1 to 20:1, 7:1 to 15:1, 15:1 to 30:1, 15:1 to 25:1, 15:1 to 20:1, 20:1 to 30:1, or about 25:1 to 30:1.

In some aspects, the core composition comprises a combined wt % of the first polyolefin and the stiffening polyolefin of from about 10% to about 65% by weight of the core composition, from about 15% to about 50% by weight of the core composition, including exemplary values of a combined wt % of about 10%, 20%, 30%, 40%, 50%, 60%, or about 65% by weight of the core composition. The core composition can comprise a combined wt % of the first polyolefin and the stiffening polyolefin, for example, of about 10% to 60%, about 10% to 50%, about 10% to 40%, about 10% to 30%, about 20% to 65%, about 20% to 50%, about 20% to 40%, about 30% to 65%, about 30% to 50%, or about 40% to about 65% by weight of the core composition.

In some aspects, the core composition comprises a combined wt % of the first polyolefin and the stiffening polyolefin of from about 20% to about 40% by weight of the core composition, such as from about 20% to about 30% % by weight of the core composition, including exemplary values of a combined wt % of about 20%, 25%, 26%, 30%, 35%, or about 40% by weight of the core composition. The core composition can comprise a combined wt % of the first polyolefin and the stiffening polyolefin, for example, of about 20% to 35%, about 20% to 30%, about 20% to 25%, about 25% to 40%, about 25% to 35%, about 25% to 30%, about 30% to 40%, or about 35% to about 40% by weight of the core composition. In a further aspect, the core composition comprises a combined wt % of the first polyolefin and the stiffening polyolefin of about 26% by weight of the core composition.

In some aspects, the core composition further comprises a compatibilizer. A compatibilizer can enhance miscibility and blending between immiscible blends of polymers. In a further aspect, the compatibilizer can be a grafted copolymer. In one aspect, the compatibilizer is a polypropylene grafted resin. In a further aspect, the compatibilizer is a high density polyethylene grafted with maleic anhydride. Commercial examples of compatibilizers are Exxelor PO1020, manufactured by The Compound Company, and Polybond 3200 or Polybond 3029, manufactured by SI Group.

In some aspects, when the compatibilizer is a polymer grafted with maleic anhydride, the maleic anhydride content can be from about 0.3% to about 2.5% by weight of the compatibilizer, including exemplary maleic anhydride values of about 0.5% by weight of the compatibilizer, about 1.0% by weight of the compatibilizer, about 1.5% by weight of the compatibilizer, about 2.0% by weight of the compatibilizer, and about 2.5% by weight of the compatibilizer. In further aspects, the maleic anhydride content can be at least about 0.5% by weight of the compatibilizer, at least about 1.0% by weight of the compatibilizer, at least about 1.5% by weight of the compatibilizer, or at least about 2.0% by weight of the compatibilizer. In yet further aspects, the maleic anhydride content can be at most about 2.5% by weight of the compatibilizer. In still further aspects, the maleic anhydride values can comprise a weight percent of the compatibilizer in a range derived from any two of the above listed exemplary weight percentage values. For example, the compatibilizer can comprise maleic anhydride in a range of from about 0.3% to about 2.0% by weight, from about 0.3% to about 1.5% by weight, from about 0.5% to about 2.0% by weight, or from about 0.5% to about 1.5%. In a further aspect, the compatibilizer comprises a maleic anhydride amount of from about 0.5% to about 1.0% by weight. In a still further aspect, the compatibilizer comprises a maleic anhydride amount of from about 0.8% to about 1.2% by weight.

In some aspects, the compatibilizer has a melt mass-flow rate from about 415 g/10 min to about 445 g/10 min at 230° C./2.16 kg as determined by ASTM D1238, including exemplary values of 420 g/min at 230° C./2.16 kg, 425 g/10 min at 230° C./2.16 kg, 430 g/10 min at 230° C./2.16 kg. 435 g/10 min at 230° C./2.16 kg, 440 g/10 min at 230° C./2.16 kg, and 445 g/10 min at 230° C./2.16 kg. In still further aspects, the compatibilizer has a mass melt flow-rate in a range derived from any two of the above listed exemplary mass melt flow-rate values. For example, the compatibilizer can have a mass melt flow-rate in a range of from about 420 g/10 min to 445 g/10 min at 230° C./2.16 kg, from about 420 g/10 min to about 440 g/10 min at 230° C./2.16 kg, and from about 425 g/10 min to about 435 g/10 min at 230° C./2.16 kg. In one aspect, the compatibilizer has a melt mass-flow rate of about 430 g/10 min at 230° C./2.16 kg.

In some aspects, the compatibilizer has a melt mass-flow rate from about 105 g/10 min to about 125 g/10 min at 190° C./2.16 kg as determined by ASTM D1238, including exemplary values of about 105 g/10 min at 190° C./2.16 kg, about 110 g/10 min at 190° C./2.16 kg, about 115 g/10 min at 190° C./2.16 kg, about 120 g/10 min at 190° C./2.16 kg, and 125 g/10 min at 190° C./2.16 kg. In still further aspects, the compatibilizer has a mass melt flow-rate in a range derived from any two of the above listed exemplary mass melt flow-rate values. For example, the compatibilizer can have a mass melt flow-rate in a range of from about 105 g/10 min to about 125 g/10 min at 190° C./2.16 kg, from about 105 g/10 min to about 120 g/10 min at 190° C./2.16 kg, and from about 110 g/10 min to about 120 g/10 min at 190° C./2.16 kg. In one aspect, the compatibilizer has a melt mass-flow rate of about 115 g/10 min at 190° C./2.16 kg.

In some aspects, the compatibilizer has a melt mass-flow rate from about 1 g/min to about 10 g/10 min at 190° C./2.16 kg as determined by ASTM D1238, including exemplary values of about 1 g/10 min at 190° C./2.16 kg, about 2 g/10 min at 190° C./2.16 kg, about 4 g/10 min at 190° C./2.16 kg, about 6 g/10 min at 190° C./2.16 kg, about 8 g/10 min at 190° C./2.16 kg, and about 10 g/10 min at 190° C./2.16 kg. In still further aspects, the compatibilizer has a mass melt flow-rate in a range derived from any two of the above listed exemplary mass melt flow-rate values. For example, the compatibilizer can have a mass melt flow-rate in a range of from about 1 g/10 min to about 8 g/10 min at 190° C./2.16 kg, from about 2 g/10 min to about 10 g/10 min at 190° C./2.16 kg, and from about 2 g/10 min to about 5 g/10 min at 190° C./2.16 kg. In one aspect, the compatibilizer has a melt mass-flow rate of about 4 g/10 min at 190° C./2.16 kg.

In a further aspect, the core composition can comprise the compatibilizer in an amount of from greater than 0% to about 10% percent by weight of the core composition, including exemplary filler values of 0.5% by weight, 1% by weight, 5% by weight, and 10% by weight. In further aspects, the core composition can comprise the compatibilizer in an amount of at least about 0.5% by weight, at least about 1% by weight, and at least about 5% by weight of the core composition. In yet further aspects, the core composition can comprise the compatibilizer in an amount of at most about 10% by weight of the core composition. In still further aspects, the core composition can comprise a compatibilizer in a range derived from any two of the above listed exemplary weight percentage values. For example, the core composition can comprise a compatibilizer in a range of from about 0.5% to about 10% by weight, from about 0.5% to about 5% by weight, from greater than 0% to about 10% by weight, or from greater than 0% to about 5% by weight. In a further aspect, the core composition comprises a compatibilizer in an amount of from greater than 0% to about 10% by weight.

In a further aspect, the core composition comprises from about 10% to about 30% by weight of the first polyolefin, from greater than 0% by weight to about 15% by weight of the stiffening polyolefin, and from greater than 0% by weight to about 10% by weight of a compatibilizer.

In some aspects, the core layer has a thickness of from about 1 mm to about 20 mm, including exemplary values of about 1 mm, 2 mm. 3 mm, 4 mm, 5 mm, 6 mm, 7 mm. 8 mm, 9 mm, 10 mm, 1 mm, 12 mm, 13 mm. 14 mm, 15 mm, 16 mm, 17 mm. 18 mm, 19 mm, and 20 mm. In still further aspects, the core layer can have a thickness in a range derived from any two of the above listed exemplary thicknesses. For example, the core layer can have a thickness in a range of from about 1 to about 15 mm, from about 1 to about 10, mm, from about 1 to about 9 mm, from about 1 to about 8 cm, from about 2 to about 9 cm, or from about 2 to about 8 cm. In a further aspect, the core layer has a thickness of from about 2 mm to about 5 mm.

In various aspects, the core composition does not comprise polyvinyl chloride.

In some aspects, the core layer is a single extruded layer. In a further aspect, the core layer and a balancing layer, when present, can be co-extruded.

### 2. Decorative Portion

According to aspects of the invention, the decorative article comprises a decorative portion having a top surface and an opposing bottom surface. In a yet further aspect, the top surface of the core layer is attached to the bottom surface of the decorative portion. See FIGS. 1-4.

For example, as is generally depicted in FIG. 3, the decorative article 300 can comprise a core layer 310, an optional balancing layer 305, and a decorative portion 320 comprising an optional primer 330, a tie layer 340, and an image layer 350.

In one aspect, the decorative portion comprises at least one of, polypropylene (PP), polyethylene (PE), polyethethylene terephthalate (PET), thermoplastic polyurethane (TPU), glycol-modified polyethylene terephthalate (PETG), polyurethane, polytrimethylene terephthalate (PTT), Nylon 6, or Nylon 6,6.

In various aspects, the decorative portion comprises a primer. In a further aspect, the primer has a top surface and an opposing bottom surface. In some aspects, the primer is applied onto the top surface of the core layer. In a yet further aspect, the primer can be a water borne coating primer, including, for example and without limitation, G-680 Primer manufactured by Mica Corporation. In a yet still further aspect, the primer can be a UV cured primer, including, for example and without limitation, a polyurethane-based UV curable primer.

In various aspects, the decorative portion comprises an image layer. In some aspects, the image layer comprises an image printed directly upon the top surface of the core layer. That is, the image layer comprises an ink layer that is printed on the core layer. In certain aspects, the image layer comprises a printed film layer.

In some aspects, the printed film layer comprises a substrate layer and an ink layer. In still further aspects, the ink layer has a top surface and an opposing bottom surface. In a yet further aspect, at least a layer of the top surface of the ink layer defines at least a portion of the top surface of the decorative portion.

In certain aspects, the substrate layer of the printed film layer has a top surface and an opposing bottom surface. In still further aspects, the ink layer can be applied to the top surface of the substrate layer. Optionally, the ink layer can be applied to the bottom surface of the substrate layer. In certain aspects, the bottom surface of the substrate layer can define the bottom surface of the decorative portion overlying the top surface of the core layer.

In certain aspects, it is contemplated that the ink layer can be applied either directly or indirectly to the top surface of the substrate layer. In a further aspect, the ink layer can comprise any conventional ink, dye, pigment, or other marking substance that can be applied within the composite plank in a desired pattern. For example and without limitation, the ink layer can comprise water-based, soy-based, a UV-cured inks, and/or solvent-based pigments. In still further aspect, the ink layer is a UV cured ink.

It is understood that UV-cured inks can comprise photo-initiators, pigments, additives, monomers and oligomers of various polymers, and the like. In some exemplary aspects, the UV-cured inks can comprise, without limitation, (5-ethyl-1,3-dioxan-5yl)methyl acrylate, 2-phenoxyethyl acrylate: 1-vinylhexahydro-2H-azepin-2-one, substituted phosphine oxide, thrimethylolpropane triacrylate, phenyl bis (2,4 6-trimethylbenzoyl)phosphine oxide, epoxy acrylate oligomer, diacrylate monomer, multi-functional monomers, amine modified acrylate oligomer, 1-vinylhexahydro-2H-asepin-2-one, diacrylate oligomers, benzophenone, triacryalte monomers, 1-hvdroxV-cyclohexylphenyl-ketone. 2 hydroxy-2-methylpropiophenone, and the like.

In a further aspect, the ink layer can be applied to the substrate layer by any appropriate printing means, which can include, without limitation, rotogravure printing, flexography printing, lithography printing, offset-lithography printing, relief printing, thermography printing, thermal sublimation printing, dye-sublimation printing, heat-transfer printing, digital printing, and the like.

In still further aspects, the ink layer can be applied by a digital printing. In an exemplary aspect, the ink layer can comprise inks and pigments manufactured by Collins Inks, INX Inks, Durst, HP, EFI, Sun Chemical, or Tiger. In yet other aspects, the ink layer can be digitally printed utilizing digital printers manufactured by Cefla, Durst, Hymmen. EFI, Barbaran or Inca.

In certain aspects, the formed ink layer can be a continuous layer that covers substantially the entire top surface of the substrate layer. In yet other aspects, the formed ink layer can be a discontinuous layer that covers only a portion of the top surface of the substrate layer. In yet other aspects, the ink layer can have any desired aesthetic appearance, such as, for example and without limitation, the appearance of simulated hardwood or ceramic flooring. In some aspects, the thickness, concentration, etc., of the ink layer may or may not be uniform over the entire top surface of the substrate layer.

In some aspects, the substrate layer is whitened or opaque. In yet other aspects, the substrate layer can comprise any whitening agent known in the art. It is further understood that the whitening agent disclosed herein can comprise inorganic and/or organic compounds. In yet other aspects, the whitening agent can be a fluorescent whitening agent. In some exemplary aspects, the whitening chemistry comprises titanium dioxide, zinc dioxide, and the like. In some other aspects, the whitening can be also achieved by cavitation. In some aspects, the substrate may be a solid colored layer that provides a contrasting background for the image to be printed thereon and said image to stand out and add to the clarity thereof. For example, the substrate may be white or an off-white color.

In certain aspects, the substrate layer has a thickness from about 1 mil to about 20 mil, including exemplary values of about 2 mil, about 3 mil, about 4 mil, about 5 mil, about 6 mil, about 7 mil, about 8 mil, about 9 mil, about 10 mil, about 11 mil, about 12 mil, about 13 mil, about 14 mil, about 15 mil, about 16 mil, about 17 mil, about 18 mil, and about 19 mil. In still further aspects, the substrate layer can have any thickness in a range derived from any two of the above listed exemplary values. For example, the substrate layer can comprise a thickness in a range of from about 1 mil to about 5 mil, or from about 3 mil to about 7 mil. In still further aspects, the substrate layer can be a film.

In various aspects, the decorative portion comprises a tie layer disposed between the ink layer or image layer and the core layer. In a further aspect, the tie layer comprises an adhesive composition that is added to the primer to promote adhesion between the top surface of the primer and the bottom surface of the image layer or the ink layer.

### 3. Tie Layer

According to various further aspects, the decorative article further comprises a tie layer. In certain aspects, the tie layer comprises at least one tie layer. In yet other aspects, the tie layer can comprise a plurality of tie layers. In still further aspects, the tie layer comprises an adhesive composition. In other aspects, the tie layer has a top surface and an opposing bottom surface. In yet other aspects, a tie layer can substantially overly the decorative portion such that at least a portion of the top surface of the tie layer contacts and adheres to the bottom surface of the image layer. In yet other aspects, a tie layer can substantially overlay the balancing layer such that at least a portion of the top surface of the tie layer contacts and adheres to the bottom surface of the core layer. In yet still other aspects, a tie layer can substantially overly the decorative portion such that at least a portion of the surface of the tie layer contacts and adheres to the bottom surface of the wear layer. In such an aspect, the bottom portion of the tie layer can adhere to the top surface of the image layer, such as adhering to the ink layer. Thus, the decorative article can comprise two tie layers, one tie layer arranged between the image layer and the core layer or primer, and one tie layer arranged between the wear layer and the image layer. In one example, the decorative article can comprise one tie layer being either: 1, a tie layer arranged between the image layer and the core layer or primer, or 2, a tie layer arranged between the wear layer and the image layer.

In some aspects, the decorative portion is affixed to the top surface of the core layer with an adhesive. In some aspects, the adhesive comprises at least one of acrylic adhesive, ethylene-vinyl acetate (EVA), ethylene-acrylic acid (EAA), ethylene-acrylic acid-maleic anhydride (EAA-MAH), ethylene-methyl acrylate-maleic anhydride (EMA-MAH), ethylene-vinyl acetate-maleic anhydride (EVA-MAH), low density-polyethylene-maleic anhydride (LDPE-MAH), high density polyethylene-maleic anhydride (HDPE-MAH), polyurethane (PUR), polyurethane dispersions (PUD), a polyester hotmelt, a UV-curable adhesive, or a combination thereof. In some aspects, the tie layer comprises at least one of: polyethylene terephthalate (PET), ethylene-vinyl acetate (EVA), polyurethane (PUR), polyethyleneimine (PEI), water borne extrusion coating primers, conventional acrylic materials, maleic anhydride (MAH), or ethylene-methyl acrylate (EMA). In a further aspect, the tie layer comprises at least one of: ethylene-acrylic acid (EAA), ethylene methyl acrylate (EMA), ethylene-acrylic acid-maleic anhydride (EAAMAH), ethylene-methyl acrylate-maleic anhydride (EMAMAH), ethylene-vinyl acetate-maleic anhydride (EVAMAH), low density polyethylene-maleic anhydride (LDPEMAH), high density polyethylene-maleic anhydride (HDPE-MAH), polyurethane (PUR), polyurethane dispersion (PUD), or acrylic.

In some aspects, the UV-curable adhesives can comprise polyurethane acrylate-based main-chain polymers, polyisoprene acrylate-based main chain polymers, polybutadiene acrylate-based main-chain polymers, monomeric (meth) acrylates, and the like. In certain aspects, the UV-curable adhesives can comprise any adhesives known in the art that are capable of being cured upon exposure to a UV light. In other aspects, the UV-curable adhesive can further comprise other additives such as, for example, and without limitation photo-polymerization initiators, additives that increase flexibility of the resin, and the like.

The adhesive can comprise substantially linear ethylene polymers and homogeneously branched linear ethylene polymers (i.e., homogeneously branched ethylene polymers). Homogeneously branched ethylene polymers (including substantially linear ethylene polymers in particular) have low solidification temperatures, good adhesion to polypropylene, and low modulus relative to conventional ethylene polymers such as low density polyethylene (LDPE), heterogeneously branched linear low density polyethylene (LLDPE), high density polyethylene (HDPE), and heterogeneously branched ultra-low density polyethylene (ULDPE).

In certain aspects, the adhesive has a thickness of about 0.1 mil to about 5 mil, including exemplary values of about 0.5 mil, about 1 mil, about 1.5 mil, about 2 mil, about 2.5 mil, about 3 mil, about 3.5 mil, about 4 mil, and about 4.5 mil. In still further aspects, the adhesive can have any thickness in a range derived from any two of the above listed exemplary values. For example, the adhesive can comprise a thickness in a range of from about 0.5 mil to about 4 mil, or from about 0.1 mil to about 3 mil.

In a further aspect, when the core layer and the balancing layer both comprise UV curable materials, the decorative article does not comprise a tie layer arranged between the core layer and the balancing layer.

### 4. Wear Layer

According to various aspects of the invention, the decorative article comprises a wear layer. In certain aspects, the wear layer has a top surface and an opposing bottom surface. In further aspects, the wear layer substantially overlies the tie layer such that at least a portion of the bottom surface of the wear layer contacts and adheres to at least a portion of the top surface of the tie layer.

In certain aspects, the top surface of the wear layer can be configured for exposure to an ambient environment.

In yet other aspects, the wear layer can be heat laminated to the decorative portion using a tie layer as an adhesive.

In one aspect, the wear layer can comprise, for example and without limitation, ionomers, polyethylene terephthalate (PET), polyurethane, polypropylene, polytrimethylene terephthalate (PTT), nylon 6, nylon 6,6, polyethylene, and the like. In a further aspect, the wear layer can comprise surlyn resin, such as, for example and without limitation, SurlynR>1706 resin, manufactured by E.I. du Pont de Nemours and Company, Inc. In a still further aspect, the wear layer can comprise heat stabilized biaxially-oriented PET (BoPET), amorphous PET (aPET), recycled PET (rPET), polyethylene terephthalate glycol-modified (PETG), polyolefin, cyclic olefin copolymer (COC), cyclic olefin polymer (COP), polylactic acid (PLA) copolymers, nylon, cellulose acetate, poly(methyl methacrylate) (PMMA), thermoplastic polyurethane (TPU), thermoplastic elastomers (TPE), polycarbonate, polyethylene (PE), high density polyethylene (HDPE), low density polyethylene (LDPE), or a copolymer thereof.

In some aspects, the wear layer comprises a UV stabilizer.

In some aspects, the wear layer is substantially transparent. In other aspects, the wear layer is substantially opaque.

In a vet further aspect, the wear layer can have a thickness in the range of from about 4 mil to about 30 mil, including exemplary thickness ranges of from about 4 to about 8 mil, about 9 to about 14 mil, or about 16 to about 30 mil. In a still further aspect, the thickness can be in a range derived from any of the above listed exemplary values. For example, the thickness can in the range of about 4 mil to about 9 mil, or from 4 mil to about 16 mil. In another aspect, the wear layer can be embossed with a desired texture pattern.

The wear layer can be strongly adhered to the ink layer by use of the tie layer. Without being bound by any theory, it is contemplated that the tie layer improves a compatibility of the two incompatible layers: the ink layer and the wear layer. In the aspects when the tie layer allows to bond otherwise dissimilar materials that form the otherwise opposing layers of the floor covering together.

In various aspects, the top surface of the wear layer can further comprise a scratch layer. In one aspect, the scratch layer can comprise polyurethane, or acrylate, or a combination thereof. In a further aspect, the scratch layer can comprise a mixture of reactive monomers and oligomers. In a still further aspect, the scratch layer can comprise functionalized monomers, for example, and without limitation, difunctional and multifunctional monomers. In an even further aspect, the scratch layer can comprise at least one photoinitiator, or other component to catalyze a reaction among materials present in the scratch layer. In some aspects, the scratch layer comprises a blend of epoxy acrylate oligomers with difunctional and multifunctional monomers. In still further aspects, the scratch layer is UV-cured scratch layer.

In a further aspect, the scratch layer comprises at least one of corundum, emery, granite, quartz, aluminum oxide, silica, or trap rock, or a combination thereof.

In a further aspect, the scratch layer has a thickness in the range of from about 0.25 to about 3 mils, including exemplary ranges of from about 0.50 to about 1.25 mils, and 0.50 to about 2.25 mils. In a still further aspect, the surface hardening agent is present in an amount in the range of from about 0.25 weight % to about 15 weight % based upon the total weight of the scratch layer, including exemplary ranges of from about 2 weight % to about 3 weight %, and about 2 weight % to about 10 weight % based upon the total weight of the scratch layer. In some aspects, the surface hardening agent is present in an amount less than or equal to 10 weight %, for example, less than about 9, 8, 7, 6, 5, 4, 3, 2, or 1 weight % based upon the total weight of the scratch layer. In a further aspect, the surface hardening agent comprises particulate material having an average particle size less than or equal to 20 microns, for example, less than or equal to about 15, 10, 9, 8, 7, 6, 5, 4, 3, 2, or 1 micron. In some aspects, the scratch layer is adhered to an underlying wear layer portion by a primer coating layer. In a further aspect, the primer coating layer has a thickness in the range of from about 0.25 to about 1 mil, for example, from about 0.40 to about 0.6 mil.

In a further aspect, the decorative article can optionally comprise atop layer. In a further aspect, the scratch layer is the top layer. In a yet further aspect, the scratch layer is not the top layer. In some aspects, the scratch layer may be different from the wear layer and disposed over the wear layer. In said aspects, the top surface of the wear layer is configured to not be exposed to the ambient environment. In further aspects, the decorative article may comprise a topcoat layer that forms the top most layer of the decorative article. In some examples, the topcoat layer may be disposed above the wear layer and the decorative article may not include a scratch coat. In other examples, the topcoat layer may be disposed above the scratch layer which in turn is disposed over the wear layer.

### 4. Balancing Layer

In various aspects, the decorative article can further comprise a balancing layer having a top surface and an opposing bottom surface. In a further aspect, the balancing layer can provide additional dimensional stability to and reduce curling in the decorative article. For example, the presence of the balancing layer can allow for the decorative article to pass the ISO 23999 test as described herein. The balancing layer also counteracts the stress in the core layer caused by the decorative portion. When present in the decorative article, the top surface of the balancing layer is attached to the bottom surface of the core layer, see FIGS. 2-4. When present in the decorative article, the balancing layer has less filler than the core layer.

In one aspect, the balancing layer comprises at least one of a non-woven material comprising polypropylene, a non-woven material comprising polyethylene terephthalate, a point bond material comprising polypropylene, a point bond material comprising polyethylene terephthalate, a film comprising polypropylene, a film comprising polyethylene, or UV lacquer. In a further aspect, the balancing layer comprises a UV lacquer. In a yet further aspect, the UV lacquer is acrylic resin.

In various aspects, the balancing layer comprises at least one of polyethylene terephthalate (PET), ethylene-vinyl acetate (EVA), polyurethane (PUR), polyethyleneimine (PEI), water bome extrusion coating primers, conventional acrylic materials, maleic anhydride (MAH), or ethylene-methyl acrylate (EMA). In a further aspect, the balancing layer comprises at least one of: ethylene-acrylic acid (EAA), ethylene methyl acrylate (EMA), ethylene-acrylic acid-maleic anhydride (EAAMAH), ethylene-methyl acrylate-maleic anhydride (EMAMAH), ethylene-vinyl acetate-maleic anhydride (EVAMAH), low density polyethylene-maleic anhydride (LDPEMAH), high density polyethylene-maleic anhydride (HDPE-MAH), polyurethane (PUR), polyurethane dispersion (PUD), or acrylic.

In some aspects, the balancing layer comprises polypropylene or polyethylene terephthalate. In a further aspect, the balancing layer comprises polypropylene. In a yet further aspect, the balancing layer comprises polyethylene terephthalate.

In some aspects, the balancing layer comprises the first polyolefin described herein.

In some aspects, the balancing layer comprises from about 25% to about 60% by weight of the first polyolefin. The balancing layer can comprise, for example, from about 25% to 55%, about 25% to 50%, about 25% to 45%, about 25% to 40%, about 25% to 30%, about 30% to 60%, about 30% to 55%, about 30% to 50%, about 30% to 45%, about 30% to 40%, about 40% to 60%, about 40% to 55%, about 40% to 50%, about 40% to 45%, about 45% to 60%, about 45% to 55%, about 45% to 50%, about 50% to 60%, or about 55% to 60% by weight of the first polyolefin. The balancing layer can comprise, for example, about 25%, 30%, 35%, 40%, 45%, 50%, 55%, or about 60% by weight of the first polyolefin.

In some aspects, the balancing layer is co-extruded with the core layer. In a yet still further aspect, the balancing layer comprises polypropylene or polyethylene and is co-extruded with the core layer. In various aspects, the balancing layer is extruded separately from the core layer and the top surface of the balancing layer is attached to the bottom surface of the core layer using a tie layer. In a further aspect, the balancing layer is formed separately from the core layer and the top surface of the balancing layer is attached to the bottom surface of the core layer using a tie layer.

In some aspects, when the core layer and the balancing layer comprise the same type of polymer, the balancing layer is directly heat laminated with the core layer.

In some aspects, the balancing layer comprises a stiffening polyolefin. In some aspects, a stiffening polyolefin which can be used to produce the balancing layer include, but are not limited to, polyolefins comprising polyethylene, polypropylene, both homopolymer and copolymers, poly(1-butene), poly(3-methyl-1-butene), poly(4-methyl-1-pentene) and the like, as well as combinations or mixtures of two or more of the foregoing. The stiffening polyolefin can be a copolymer or a homopolymer. In some aspects, the stiffening polyolefin is a homopolymer. In a further aspect, the stiffening polyolefin is a copolymer. In a further aspect, the stiffening polyolefin comprises polypropylene. A commercial example of a stiffening polyolefin is PP1024E4, which is manufactured by ExxonMobil Chemical Company.

In some aspects, the stiffening polyolefin has a melt mass-flow rate from about 10 g/10 min to about 18 g/10 min at 230° C./2.16 kg as determined by ASTM D1238, including exemplary values of about 11 g/10 min at 230° C./2.16 kg, about 12 g/10 min at 230° C./2.16 kg, about 13 g/10 min at 230° C./2.16 kg, about 14 g/10 min at 230° C./2.16 kg, about 15 g/10 min at 230° C./2.16 kg, about 16 g/10 min at 230° C./2.16 kg, and about 17 g/10 min at 230° C./2.16 kg. In still further aspects, the stiffening polyolefin has a mass melt flow-rate in a range derived from any two of the above listed exemplary mass melt flow-rate values. For example, the stiffening polyolefin can have a mass melt flow-rate in a range of from about 10 g/10 min to about 15 g/10 min at 230° C./2.16 kg, from about 12 g/10 min to about 17 g/10 min at 230° C./2.16 kg, and from about 12 g/10 min to about 14 g/10 min at 230° C./2.16 kg. In one aspect, the stiffening polyolefin has a melt mass-flow rate of about 13 g/10 min at 230° C./2.16 kg.

In a further aspect, the balancing layer can comprise the stiffening polyolefin in an amount of from greater than 0% to about 10% percent by weight of the balancing layer, including exemplary filler values of about 0.5% by weight, about 1% by weight, about 3% by weight, about 5% by weight, about 7% by weight, or about 10% by weight. In further aspects, the balancing layer can comprise the stiffening polyolefin in an amount of at least about 0.5% by weight, at least about 1% by weight, at least about 5% by weight, or at least about 10% by weight. In yet further aspects, the balancing layer can comprise the stiffening polyolefin in an amount of at most about 10% by weight. In still further aspects, the balancing layer can comprise a stiffening polyolefin in a range derived from any two of the above listed exemplary weight percentage values. For example, the balancing layer can comprise a stiffening polyolefin in a range of from about 0.5% to about 10% by weight, from about 0.5% to about 8% by weight, from greater than 0% to about 8% by weight, or from greater than 0% to about 5% by weight. In a further aspect, the core composition comprises a stiffening polyolefin in an amount of from about 0.5% to about 10% by weight.

In some aspects, the balancing layer can comprise a weight/weight ratio of the first polyolefin:stiffening polyolefin of from about 10:1 to about 50:1, including exemplary ratios of first polyolefin:stiffening polyolefin of about 10:1, 13:1, 16:1, 20:1, 25:1, 30:1, 39:1, 40:1, or about 50:1. In further aspects, compthe balancing layer can comprise a weight/weight ratio of the first polyolefin:stiffening polyolefin of from about 10:1 to 40:1, about 10:1 to 30:1, about 10:1 to 25:1, about 10:1 to 20:1, about 10:1 to 16:1, about 13:1 to 50:1, about 13:1 to 39:1, about 13:1 to 30:1, about 13:1 to 25:1, about 13:1 to 20:1, about 20:1 to 50:1, about 20:1 to 39:1, about 20:1 to 25:1, about 25:1 to 50:1, about 25:1 to 39:1, or about 39:1 to about 50:1. In some aspects, the balancing layer comprises a combined w-t % of the first polyolefin and the stiffening polyolefin of from about 25% to about 70% by weight of the balancing layer, including exemplary values of a combined wt % of about 25%, 30%, 40%, 50%, 60%, or about 65% by weight of the balancing layer. The balancing layer can comprise a combined wt % of the first polyolefin and the stiffening polyolefin, for example, of about 25% to 65%, about 25% to 50%, about 25% to 40%, about 25% to 30%, about 30% to 65%, about 30% to 50%, about 30% to 40%, about 40% to 70%, about 40% to 60%, or about 50% to about 70% by weight of the balancing layer. In a further aspect, the balancing layer comprises a combined wt % of the first polyolefin and the stiffening polyolefin of from about 40% to about 55% by weight of the balancing layer.

In some aspects, the balancing layer further comprises a compatibilizer. As is known in the art, a compatibilizer enhances miscibility and blending between immiscible blends of polymers. In a further aspect, the compatibilizer can be a grafted copolymer. In one aspect, the compatibilizer is a polypropylene grafted resin. In a further aspect, the compatibilizer is a high density polyethylene grafted with maleic anhydride. Commercial examples of compatibilizers are Excelor PO1020, manufactured by ExxonMobil Chemical Company, and Polybond 3200, manufactured by SI Group.

In some aspects, when the compatibilizer is a polymer grafted with maleic anhydride, the maleic anhydride content can from about 0.3% to about 2.5% by weight of the compatibilizer, including exemplary maleic anhydride values of 0.5% by weight of the compatibilizer. 1.0% by weight of the compatibilizer, 1.5% by weight of the compatibilizer, 2.0% by weight of the compatibilizer, and 2.5% by weight of the compatibilizer. In still further aspects, the maleic anhydride values can comprise a weight percent of the compatibilizer in a range derived from any two of the above listed exemplary weight percentage values. For example, the compatibilizer can comprise maleic anhydride in a range of from about 0.3% to about 2.0% by weight, from about 0.3% to about 1.5% by weight, from about 0.5% to about 2.0% by weight, or from about 0.5% to about 1.5%. In a further aspect, the compatibilizer comprises a maleic anhydride amount of from about 0.5% to about 1.0% by weight. In a still further aspect, the compatibilizer comprises a maleic anhydride amount of from about 0.8% to about 1.2% by weight.

In some aspects, the compatibilizer has a melt mass-flow rate from about 415 g/10 min to about 445 g/10 min at 230° C./2.16 kg as determined by ASTM D1238, including exemplary values of about 420 g/min at 230° C./2.16 kg, about 425 g/10 min at 230° C./2.16 kg, about 430 g/10 min at 230° C./2.16 kg, about 435 g/10 min at 230° C./2.16 kg, about 440 g/10 min at 230° C./2.16 kg, and about 445 g/10 min at 230° C./2.16 kg. In still further aspects, the compatibilizer has a mass melt flow-rate in a range derived from any two of the above listed exemplary mass melt flow-rate values. For example, the compatibilizer can have a mass melt flow-rate in a range of from about 420 g/10 min to 445 g/10 min at 230° C./2.16 kg, from about 420 g/10 min to about 440 g/10 min at 230° C./2.16 kg, and from about 425 g/10 min to about 435 g/10 min at 230° C./2.16 kg. In one aspect, the compatibilizer has a melt mass-flow rate of about 430 g/10 min at 230° C./2.16 kg.

In some aspects, the compatibilizer has a melt mass-flow rate from about 105 g/10 min to about 125 g/10 min at 190° C./2.16 kg as determined by ASTM D1238, including exemplary values of about 105 g/min at 190° C./2.16 kg, about 110 g/10 min at 190° C./2.16 kg, about 115 g/10 min at 190° C./2.16 kg, about 120 g/10 min at 190° C./2.16 kg, and about 125 g/10 min at 190° C./2.16 kg. In still further aspects, the compatibilizer has a mass melt flow-rate in a range derived from any two of the above listed exemplary mass melt flow-rate values. For example, the compatibilizer can have a mass melt flow-rate in a range of from about 105 g/10 min to about 125 g/10 min at 190° C./2.16 kg, from about 105 g/10 min to about 120 g/10 min at 190° C./2.16 kg, and from about 110 g/10 min to about 120 g/10 min at 190° C./2.16 kg. In one aspect, the compatibilizer has a melt mass-flow rate of about 115 g/10 min at 190° C./2.16 kg. In certain aspects, when the balancing layer is co-extruded with the core layer, the balancing layer comprises from greater than 0% to about 40% of the filler, from about 20% to about 50% of the first polyolefin, greater than 0% to about 15% of a stiffening polyolefin, and greater than 0% to about 10% of a compatibilizer.

In a further aspect, the balancing layer can comprise the compatibilizer in an amount of from greater than 0% to about 10% percent by weight of the balancing layer, including exemplary filler values of 0.5% by weight, 1% by weight, 5% by weight, and 10% by weight of the balancing layer. In further aspects, the balancing layer can comprise the compatibilizer in an amount of at least about 0.5% by weight, at least about 1% by weight, and at least about 5% by weight of the balancing layer. In yet further aspects, the balancing layer can comprise the compatibilizer in an amount of at most about 10% by weight of the balancing layer. In still further aspects, the balancing layer can comprise a compatibilizer in a range derived from any two of the above listed exemplary weight percentage values. For example, the balancing layer can comprise a compatibilizer in a range of from about 0.5% to about 10% by weight, from about 0.5% to about 5% by weight, from greater than 0% to about 10% by weight, or from greater than 0% to about 5% by weight of the balancing layer. In a further aspect, the balancing layer comprises a compatibilizer in an amount of from greater than 0% to about 10% by weight of the balancing layer.

In one aspect, the balancing layer does not comprise a filler. In a further aspect, the balancing layer can comprise the filler in an amount of from greater than 0% to about 60% percent by weight of the balancing layer, including exemplary values filler values of about 5% by weight, 10% by weight, 15% by weight, 20% by weight, 25% by weight, 30% by weight, 35% by weight, 40% by weight, 45% by weight, 50% by weight, and about 60% by weight of the balancing layer. In still further aspects, the balancing layer can comprise the filler in an amount of at least about 5% by weight, at least about 10% by weight, at least about 20% by weight, 30% by weight, at least about 40% by weight, at least about 50% by weight, or at least about 55% by weight of the balancing layer. In still further aspects, the balancing layer can comprise the filler in an amount of at most about 60% by weight of the balancing layer. In still further aspects, the balancing layer can comprise a filler in a range derived from any two of the above listed exemplary weight percentage values. For example, the balancing layer can comprise a filler in a range of from about greater than 0% to about 55% by weight, about 5% to about 50% by weight, about 10% to about 50% by weight, about 20% to about 50% by weight, about 30% to about 55% by weight, from about 30% to about 50% by weight, from about 30% to about 45% by weight, or from about 40% to about 55% by weight of the balancing layer. In a further aspect, the balancing layer comprises a filler in an amount of from about 30% to about 55% by weight of the balancing layer. In a still further aspect, the balancing layer comprises a filler being calcium carbonate in an amount of from about greater than 0% to about 60% by weight of the balancing layer. In a yet still further aspect, the balancing layer comprises a filler being calcium carbonate in an amount of from about 40% to about 55% by weight of the balancing layer.

In some aspects, one or more additional layers can be applied to the balancing layer such that a top surface of an additional layer can be attached to the bottom surface of the balancing layer. In some aspects, the one or more additional layers can be co-extruded with the balancing layer and the core layer. In a further aspect, the one or more additional layers can be co-extruded with the balancing layer only. In a yet further aspect, the one or more additional layers are extruded separately from the balancing layer and the top surface of the one or more additional layers is attached to the bottom surface of the balancing layer using a tie layer. In a yet still further aspect, the one or more additional layers are formed separately from the balancing layer and the top surface of the one or more additional layers is attached to the bottom surface of the balancing layer using a tie layer. In some aspects, the one or more additional layers comprise an acoustic layer. The acoustic layer can make the decorative article being more sound proof than an identical decorative article without the acoustic layer.

When a balancing layer is present in the decorative article, the balancing layer has a thickness that is lower than the thickness of the core layer. In some aspects, the balancing layer as a thickness of from about 0.1 mm to about 1.5 mm. The balancing layer can have a thickness of, for example, from about 0.1 mm to 1.4 mm, about 0.1 mm to 1.3 mm, about 0.1 mm to 1.1 mm, about 0.1 mm to 1.0 mm, about 0.1 mm to 0.8 mm, about 0.1 mm to 0.6 mm, about 0.1 mm to 0.5 mm, about 0.1 mm to 0.3 mm, about 0.2 mm to 0.3 mm, about 0.2 mm to 1.5 mm, about 0.2 mm to 1.3 mm, about 0.2 mm to 1.2 mm, about 0.2 mm to 1.0 mm, about 0.2 mm to 0.8 mm, about 0.2 mm to 0.6 mm, about 0.2 mm to 0.4 mm, about 0.4 mm to 1.5 mm, about 0.4 mm to 1.3 mm, about 0.4 mm to 1.0 mm, about 0.4 mm to 0.8 mm, about 0.4 mm to 0.6 mm, about 0.5 mm to 1.5 mm, about 0.5 mm to 1.3 mm, about 0.5 mm to 1.0 mm, about 0.5 mm to 0.8, about 0.5 mm to 0.6 mm, about 0.6 mm to 1.5 mm, about 0.6 mm to 1.3 mm, about 0.6 mm to 1.0 mm, about 0.6 mm to 0.8, about 0.8 to 1.5 mm, about 0.8 to 1.3 mm, about 0.8 to 1.0 mm, about 1.0 mm to 1.5 mm, about 1.0 mm to 1.3 mm, or about 1.3 mm to 1.5 mm. The balancing layer can have a thickness of, for example, about 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, or about 1.5 mm.

### Methods of Making Decorative Articles

In various aspects, the present disclosure also provides methods of making a decorative article, such as the decorative articles described herein. In one aspect, a method of making the decorative articles described herein can comprise a, providing a core layer from a core composition comprising a first polyolefin and a filler, wherein the formed core layer has a top surface and an opposing bottom surface, wherein the first polyolefin is an elastomer of propylene and ethylene derived units; and b, attaching a decorative portion having a top surface and an opposing bottom surface to the top surface of the core layer.

In one aspect, a method of making the decorative articles described herein can comprise providing the core layer as described herein. The core layer can be formed in an extrusion process. Thus, the method of making the decorative article can further comprise extruding the core layer. In the aspects where a balancing layer is present the balancing layer can be formed in an extrusion process. Thus, the method of making the decorative article can further comprise extruding the balancing layer. For example, the core layer and the balancing layer can be formed in a co-extrusion process. Thus, the method of making the decorative article can further comprise co-extruding the core layer and the balancing layer. In one aspect, there is no need for a tie layer between the core layer and the balancing layer when the core layer and the balancing layer are co-extruded.

The method of making the decorative article can comprise attaching the decorative portion thereto the top surface of the core layer. In a further aspect, the method of making the decorative articles described herein can comprise applying a tie layer as described herein to the top surface of the core layer. In this aspect, the method of making the decorative articles described herein can comprise attaching the decorative portion thereto the tie layer applied to the core layer. It is contemplated that the bottom surface of the decorative portion can be substantially directly applied to the top surface of the core layer or the tie layer applied thereto the core layer. It is also contemplated that the bottom surface of the decorative portion can be applied to the top surface of the core layer, or the tie layer applied thereto the core layer, using a chemical adhesive, mechanical connection, or other application means.

In a further aspect, the method of making the decorative articles described herein can further comprise attaching the bottom surface of the core layer to the top surface of a balancing layer. In a further aspect, the method of making the decorative articles described herein can comprise applying a tie layer as described herein to the top surface of the balancing layer. In this aspect, the method of making the decorative articles described herein can comprise attaching the core layer thereto the tie layer applied to the balancing layer. It is contemplated that the bottom surface of the core layer can be substantially directly applied to the top surface of the balancing layer or the tie layer applied thereto the core layer. It is also contemplated that the bottom surface of the core layer can be applied to the top surface of the balancing layer, or the tie layer applied thereto the balancing layer, using a chemical adhesive, mechanical connection, or other application means. In a further aspect, the method of making the decorative articles described herein can comprise attaching a decorative portion thereto the top surface of the core layer. In a further aspect, the method of making the decorative articles described herein can comprise applying a tie layer as described herein to the top surface of the core layer. In this aspect, the method of making the decorative articles described herein can comprise attaching the decorative portion thereto the tie layer applied to the core layer. It is contemplated that the bottom surface of the decorative portion can be substantially directly applied to the top surface of the core layer or the tie layer applied thereto the core layer. It is also contemplated that the bottom surface of the decorative portion can be applied to the top surface of the core layer, or the tie layer applied thereto the core layer, using a chemical adhesive, mechanical connection, or other application means.

In another aspect, the method of making the decorative articles described herein can comprise attaching the bottom surface of the decorative portion onto the top surface of the core layer. In a further aspect, the method of making the decorative articles described herein can comprise applying a primer onto the top surface of the decorative portion, followed by applying a tie layer to the top surface of the primer such that the top surface of the tie layer contacts and adheres to the bottom surface of the image layer. In a still further aspect, the method of making the decorative articles described herein can comprise applying a tie layer to the top surface of the ink layer such that the top surface of the tie layer contacts and adheres to the bottom surface of the wear layer.

It is further understood that in alternative aspects, the top surface of the tie layer is first applied thereto the bottom surface of the wear layer. In certain aspects, the wear layer comprises the scratch layer. In yet other aspects, the wear layer does not comprise the scratch layer. In certain aspects, the scratch layer is the top layer. In other aspects, the scratch layer is not the top layer. It is understood that the tie layer used herein can comprise one or more tie layers that are applied thereto the bottom surface of the wear layer. Further, the decorative portion alone or combined with the core layer can be applied thereto the bottom surface of the tie layer.

In some other aspects, the method of making decorative articles described herein can comprise a step of applying the bottom surface of the decorative portion onto the top surface of the core layer comprising: printing a digital image on a substrate layer to form the ink layer, wherein the substrate layer is present in the decorative portion and wherein the substrate layer has a top surface and an opposing bottom surface, wherein the ink layer is formed on the top surface of the substrate.

It is understood that digitally printed inks can comprise any UV-curable inks known in the art and described herein. It is further understood that after digitally printing the image onto the substrate, the inks are UV-cured. In some aspects, the curing process comprises one step. This type of curing process is known in the industry as an A-stage curing. In yet other aspects the curing process comprises a number of steps. In certain aspects, the curing process can comprise a first step and a second step. This type of curing process is known in the industry as a B-stage curing. In some aspects, the first step of the curing process is applied to the ink layer printed on the substrate at a curing energy lower that a curing energy usually utilized in A-stage curing processes. In still further aspects, the energy used in the first step of the B-stage curing process can be about ½ of the energy used in the A-stage curing process. In certain aspects, the first step of the B-stage curing process can produce a partially cured ink layer. In other aspects, the tie layer can be applied to this partially cured ink layer, and then a second step of the B-stage curing process is performed. In still further aspects, the tie layer can be applied to the partially cured ink layer followed by application of the wear layer, and only then the second step of the B-stage curing process is performed.

In various aspects, the tie layers described herein can comprise an adhesive composition. It is understood that the adhesive composition can comprise any desired adhesives. In a further aspect, the chemical adhesive can comprise at least one of ethylene-acrylic acid (EAA), ethylene methyl acrylate (EMA), ethylene-acrylic acid-maleic anhydride (EAAMAH), ethylene-methyl acrylate-maleic anhydride (EMAMAH), ethylene-vinyl acetate-maleic anhydride (EVAMAH), low density polyethylene-maleic anhydride (LDPEMAH), high density polyethylene-maleic anhydride (HDPE-MAH), polyurethane (PUR), polyurethane dispersion (PUD), or acrylic. In a still further aspect, the adhesive can comprise at least one of: polyethylene terephthalate (PET), ethylene-vinyl acetate (EVA), polyurethane (PUR), polyethyleneimine (PEI), water borne extrusion coating primers, conventional acrylic materials, maleic anhydride (MAH), or ethylene-methyl acrylate (EMA).

In various aspects, the disclosed layers of the decorative article can be constructed or otherwise formed by conventional methods and/or processes. Similarly, it is contemplated that the respective layers can be connected to each other in sequential or non-sequential order. Unless otherwise stated, no particular order of operative steps for product formation is required to practice the disclosed decorative articles. It is further contemplated that any conventional means of providing or joining layers of a layered construct such as the exemplified decorative article can be used, to include, without limitation, extrusion, lamination, combinations of the same, and the like. Finally, it is contemplated that after the layers of the decorative article are joined together, the resulting sheet can be cut into desired shapes and desired sizes, for example, and without limitation, into a roll goods, plank or tile shapes that can be conventionally or non-conventionally sized and/or shaped.

In certain aspects, the applying of the tie layer can be done by any methods known in the art. In some aspects, the tie layer can be extruded, casted, deposited using slot dies, or hotmelts, or any combination thereof. In some aspects, the tie layer can be melted and cast through a sheet die, and then a desired amount of the material is applied to the ink layer, or any other desirable layer. After coating the film with the extrusion process, the material can be quenched or set with a typical cooling process, such as cooling rolls, prior to the coated film being re-rolled. In a still further aspect, the tie layer can be in the form of a liquid hot melt or cold melt adhesive, and can be added onto the ink layer, the wear layer, or any other layer by a spray or roll-coating process. In a yet further aspect, and as would be recognized by one of skill in the art, the tie layer can be applied to the ink layer or any other layer while in liquid form by spray equipment or roll-coating equipment, and then dried with heat, air, or other curing means prior to re-rolling the film.

In a further aspect, each layer or portion of the decorative article can be manufactured or laminated together using traditional manufacturing methods, such as, but not limited to, a static press. As would be recognized by one of skill in the art, the method used for lamination in a static press would include the use of heat and pressure between metal plates for a specified amount of time to press together each of the desired layers described herein. For example, and without limitation, a combination of the wear layer, tie layer(s), ink, substrate layer, optional additional tie layer(s), core layer, and optional balancing layer(s) would be stacked in the desired order and placed inside the static press, then laminated together with the aforementioned combination of heat and pressure. In a still further aspect, one or more of the metal plates used to press the layers or portions of the decorative article together may include an emboss texture to transfer to the top or bottom surface of the decorative article. In a yet further aspect, this emboss texture could include a design desired for the wear layer that is inherent in the final product.

In some aspects, each individual layer or portion of the decorative article can be independently manufactured prior to the production of the decorative article.

### Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Example 1: Four core layers were produced via sheet extrusion from four core compositions and were tested. The four different core compositions are shown in Table 1 below. The core compositions in Table 1 correspond to the core layers in Table 2. For example, core layer 1 in Table 2 was produced from core composition 1 in Table 1. The first polyolefin used was Vistamaxx 6502, manufactured by Exxonmobil, having a Melt-Mass Flow Rate (MFR) of 45 g/10 min at 230° C./2.16 kg and a density of 0.87 g/cm³. The stiffening polyolefin used was PP1024, manufactured by ExxonMobil, having a MFR of 13 g/10 min at 230° C./2.16 kg and a density of 0.90 g/cm³. The compatibilizer was Exxelor PO1020, manufactured by Nexeo Plastics, having a MFR of 430 g/10 min at 230° C./2.16 kg and a density of 0.9 g/cm³.

TABLE 1

| | % by weight | | | |
|---|---|---|---|---|
| Core | First | Stiffening | | |
| Composition | polyolefin | Polyolefin | Compatibilizer | Filler |
| 1 | 25 | 1 | 3 | 71 |
| 2 | 23 | 3 | 3 | 71 |
| 3 | 21 | 5 | 3 | 71 |
| 4 | 19 | 7 | 3 | 71 |

The core layers made from the core formulations were tested for density, thickness, weight, and MFR as measured at 230° C./2.16 kg. The results are shown in Table 2. As the amount of first polyolefin decreased and the amount of stiffening polyolefin increased, the flexibility decreased and the crystallinity increased. The values in Table 2 were tested on a 6.75″ by 6.75″ sample. The density, weight, and thickness were comparable for all four core formulations. The MFR decreased with increasing amounts of stiffening polyolefin and decreasing amounts of the first polyolefin.

TABLE 2

| Core | Thickness | Weight | Density | Melt-Mass |
|---|---|---|---|---|
| layer | (mm) | (oz/y²) | (lb/ft³) | Flow Rate |
| 1 | 2.07 | 99.77 | 102.36 | 3.66 |
| 2 | 2.15 | 101.17 | 100.11 | 2.71 |
| 3 | 2.21 | 102.29 | 98.31 | 2.42 |
| 4 | 2.1 | 101.25 | 102.62 | 1.96 |

Example 2: The flexibility-drape distances of the core layers were tested using the Drape Test as illustrated in FIG. 5. The flexibility-drape distance of the core layer corresponds to the flexibility-drape distance of the decorative article. The core layer 502 is placed on the edge 508 of an elevated surface 504 and clamped in place with a clamp 506 such that a portion of the length (the testing length 507), for example 6″, 9″, 12″, 15″, 18″, or 21″ of the core layer is not directly supported by the elevated surface 504. For example, a testing length 507 of 12″ means that 12″ of the core layer 502 overhangs the edge 508 of an elevated surface 504, which is measured from the edge 508 of the elevated surface 504 to an end 514 of the core layer 502. The core layer 502 bends over the testing length 507 as shown FIG. 5. The less the bend of the core layer 502 the stiffer the core layer 502. The more the bend of the core layer 502 the more flexible the core layer 502. The distance between the underside 505 of the core layer at the edge 508 of the elevated surface 504 and the ground 510 is measured to give a distance 512. This is followed by measuring the distance between the underside 505 of the core layer 502 at an end 514 of the core layer 502 and the ground 510 to give a distance 516. The difference between distance 512 and distance 516 yields the flexibility-drape distance. These values are shown in Table 3 below. As shown by these values, the flexibility-drape distance for all testing lengths tested decreases with increasing amounts of stiffening polyolefin, i.e., the core layer exhibits less flexibility. Table 3.

| | |
|---|---|
| Core | Flexibility-drape distance (in) |

| layer | 6″ | 9″ | 12″ | 15″ | 18″ | 21″ |
|---|---|---|---|---|---|---|
| 1 | 1 | 3.125 | 6.563 | 9 | 13.75 | 17.75 |
| 2 | 0.25 | 1 | 3.125 | 7.375 | 12.688 | 15.313 |
| 3 | 0.188 | 0.75 | 2.375 | 5.563 | 9.875 | 14.75 |
| 4 | 0.188 | 1 | 2.5 | 4.5 | 8.25 | 13.25 |

Example 3: Four balancing layers were produced via sheet extrusion from four balancing layer compositions, as shown in Table 4. The same first polyolefin, stiffening polyolefin, and compatibilizer was used as in the core layer.

TABLE 4

| Balancing | % by weight | | | | |
|---|---|---|---|---|---|
| Layer | First | Stiffening | | | |
| Composition | Polyolefin | Polyolefin | Compatibilizer | Filler | Additives |
| 1 | 51 | 4 | 3 | 40 | 2 |
| 2 | 47 | 3 | 3 | 45 | 2 |
| 3 | 43 | 2 | 3 | 50 | 2 |
| 4 | 39 | 1 | 3 | 55 | 2 |

### Aspects

In view of the disclosure herein below are described certain more particularly described aspects of the inventions. These particularly recited aspects should not however be interpreted to have any limiting effect on any different claims comprising different or more general teachings described herein, or that the “particular” aspects are somehow limited in some way other than the inherent meanings of the language and formulas literally used therein.

Aspect 1: A decorative article comprising: a balancing layer having a top surface and an opposing bottom surface, a core layer having a top surface and an opposing bottom surface, wherein the decorative article comprises only one core layer being a single layer, wherein the core layer comprises a core composition comprising a first polyolefin and a filler: wherein the top surface of the balancing layer is attached to the bottom surface of the core layer, and a decorative portion having a top surface and an opposing bottom surface, wherein the top surface of the core layer is attached to the bottom surface of the decorative portion: wherein the decorative article has a flexibility-drape distance of from about 0.5″ to about 8″ as measured by a Drape Test at a length of 12″.

Aspect 2: A decorative article comprising: a core layer having a top surface and an opposing bottom surface, wherein the decorative article comprises only one core layer being a single layer, wherein the core layer comprises a core composition comprising a first polyolefin and a filler; and a decorative portion having a top surface and an opposing bottom surface, wherein the top surface of the core layer is attached to the bottom surface of the decorative portion, wherein the decorative article has a flexibility-drape distance of from about 0.5″ to about 8″ as measured by a Drape Test at a length of 12″.

Aspect 3: A decorative article comprising: a core layer having a top surface and an opposing bottom surface, wherein the decorative article comprises only one core layer being a single layer, wherein the core layer comprises a core composition comprising a first polyolefin and a filler; and a decorative portion having a top surface and an opposing bottom surface, wherein the top surface of the core layer is attached to the bottom surface of the decorative portion; wherein the decorative article passes a Mandrel bend radius test as measured according to ASTM F137.

Aspect 4: A decorative article comprising: a core layer having a top surface and an opposing bottom surface, wherein the decorative article comprises only one core layer being a single layer, wherein the core layer comprises a core composition comprising a first polyolefin and a filler; and a decorative portion having a top surface and an opposing bottom surface, wherein the top surface of the core layer is attached to the bottom surface of the decorative portion; wherein the decorative article has a maximum variation in width and a maximum variation in length of no more than about 2.0 mm when heated to a temperature of about 176° F. as measured according to ISO 23999.

Aspect 5: A decorative article comprising: a core layer having a top surface and an opposing bottom surface, wherein the decorative article comprises only one core layer being a single layer, wherein the core layer comprises a core composition comprising a first polyolefin and a filler; and a decorative portion having a top surface and an opposing bottom surface, wherein the top surface of the core layer is attached to the bottom surface of the decorative portion; wherein a curl of the decorative article as measured according to BS EN ISO 23999 is less than 0.5 mm.

Aspect 6: A decorative article comprising: a balancing layer having a top surface and an opposing bottom surface; a core layer having a top surface and an opposing bottom surface, wherein the decorative article comprises only one core layer being a single layer, wherein the core layer comprises a core composition comprising a first polyolefin and a filler, wherein the top surface of the balancing layer is attached to the bottom surface of the core layer; and a decorative portion having a top surface and an opposing bottom surface, wherein the top surface of the core layer is attached to the bottom surface of the decorative portion; wherein the decorative article passes a Mandrel bend radius test as measured according to ASTM F137.

Aspect 7: A decorative article comprising: a balancing layer having a top surface and an opposing bottom surface: a core layer having a top surface and an opposing bottom surface, wherein the decorative article comprises only one core layer being a single layer, wherein the core layer comprises a core composition comprising a first polyolefin and a filler, wherein the top surface of the balancing layer is attached to the bottom surface of the core layer; and a decorative portion having a top surface and an opposing bottom surface, wherein the top surface of the core layer is attached to the bottom surface of the decorative portion; wherein the decorative article has a maximum variation in width and a maximum variation in length of no more than about 2.0 mm when heated to a temperature of about 176° F. as measured according to ISO 23999.

Aspect 8: A decorative article comprising: a balancing layer having a top surface and an opposing bottom surface; a core layer having a top surface and an opposing bottom surface, wherein the decorative article comprises only one core layer being a single layer, wherein the core layer comprises a core composition comprising a first polyolefin and a filler, wherein the top surface of the balancing layer is attached to the bottom surface of the core layer; and a decorative portion having a top surface and an opposing bottom surface, wherein the top surface of the core layer is attached to the bottom surface of the decorative portion; wherein a curl of the decorative article as measured according to BS EN ISO 23999 is less than about 0.5 mm.

Aspect 9: A decorative article comprising: a core layer having a top surface and an opposing bottom surface, wherein the decorative article comprises only one core layer being a single layer, wherein the core layer comprises a core composition comprising a first polyolefin and a filler; and a decorative portion having a top surface and an opposing bottom surface, wherein the top surface of the core layer is attached to the bottom surface of the decorative portion; wherein the first polyolefin is an elastomer of propylene and ethylene derived units.

Aspect 10: A decorative article comprising: a balancing layer having a top surface and an opposing bottom surface: a core layer having a top surface and an opposing bottom surface, wherein the decorative article comprises only one core layer being a single layer, wherein the core layer comprises a core composition comprising a first polyolefin and a filler, wherein the top surface of the balancing layer is attached to the bottom surface of the core layer; and a decorative portion having a top surface and an opposing bottom surface, wherein the top surface of the core layer is attached to the bottom surface of the decorative portion; wherein the first polyolefin is an elastomer of propylene and ethylene derived units.

Aspect 11: The decorative article of any one of aspects 1 to 8, wherein the first polyolefin is an elastomer of propylene and ethylene derived units.

Aspect 12: The decorative article of aspect 11, wherein the elastomer is a polypropylene elastomer comprising from greater than 10 to 15 weight percent ethylene derived units based upon the weight of the polypropylene elastomer.

Aspect 13: The decorative article of aspect 11 or 12, wherein the elastomer is a polypropylene elastomer comprising from greater than 12 to 14 weight percent ethylene derived units based upon the weight of the polypropylene elastomer.

Aspect 14: The decorative article of any one of aspects 11 to 13, wherein the elastomer is a polypropylene elastomer comprising about 13 weight percent ethylene derived units based upon the weight of the polypropylene elastomer.

Aspect 15: The decorative article of any one of aspects 1 to 14, wherein the filler comprises calcium carbonate, fly-ash, recycled calcium carbonate, aluminum trihydrate, talc, nano-clay, barium sulfate, barite, barite glass fiber, glass powder, glass cullet, metal powder, alumina, hydrated alumina, clay, magnesium carbonate, calcium sulfate, silica, glass, fumed silica, carbon black, graphite, cement dust, feldspar, nepheline, magnesium oxide, zinc oxide, aluminum silicate, calcium silicate, titanium dioxide, titanates, glass microspheres, chalk, calcium oxide, or any combination thereof.

Aspect 16: The decorative article of any one of aspects 1 to 15, wherein the filler comprises calcium carbonate.

Aspect 17: The decorative article of any one of aspects 1 to 16, wherein the core composition further comprises a stiffening polyolefin.

Aspect 18: The decorative article of aspect 17, wherein the stiffening polyolefin comprises polypropylene.

Aspect 19: The decorative article of aspect 18, wherein the polypropylene is a homopolymer.

Aspect 20: The decorative article of any one of aspects 17 to 19, wherein the stiffening polyolefin has a melt mass-flow rate from about 10 g/10 min to about 18 g/10 min at 230° C./2.16 kg as determined by ASTM D1238.

Aspect 21: The decorative article of any one of aspects 1 to 20, wherein the core composition further comprises a compatibilizer.

Aspect 22: The decorative article of aspect 21, wherein the compatibilizer is a polypropylene grafted resin.

Aspect 23: The decorative article of aspect 21, wherein the compatibilizer is high density polyethylene grafted with maleic anhydride.

Aspect 24: The decorative article of any one of aspects 21 to 23, wherein the compatibilizer has a melt mass-flow rate from about 415 g/10 min to about 445 g/10 min at 230° C./2.16 kg as determined by ASTM D1238.

Aspect 25: The decorative article of any one of aspects 21 to 23, wherein the compatibilizer has a melt mass-flow rate from about 105 g/10 min to about 125 g/10 min at 190° C./2.16 kg as determined by ASTM D1238.

Aspect 26: The decorative article of any one of aspects 23 to 25, wherein the maleic anhydride content is from about 0.3% to about 2.5% by weight of the compatibilizer.

Aspect 27: The decorative article of any one of aspects 1 to 26, wherein the core composition comprises from about 45% to about 95% by weight of the filler.

Aspect 28: The decorative article of any one of aspects 1 to 27, wherein the core composition comprises from about 60% to about 80% by weight of the filler.

Aspect 29: The decorative article of any one of aspects 1 to 28, wherein the core composition comprises from about 10% to about 30% by weight of the first polyolefin.

Aspect 30: The decorative article of any one of aspects 17 to 20, wherein core composition comprises from greater than 0% by weight to about 15% by weight of the stiffening polyolefin.

Aspect 31: The decorative article of any one of aspects 21 to 26, wherein the core composition comprises from greater than 0% by weight to about 10% by weight of the compatibilizer.

Aspect 32: The decorative article of any one of claims 1 to 31, wherein the core composition comprises from about 10% to about 30% by weight of the first polyolefin, from greater than 0% by weight to about 15% by weight of the stiffening polyolefin, and from greater than 0% by weight to about 10% by weight of a compatibilizer.

Aspect 33: The decorative article of any one of aspects 1 to 32, wherein the core layer has a thickness of from about 1 mm to about 10 mm.

Aspect 34: The decorative article of any one of aspects 1 to 33, wherein the core layer has a thickness of from about 2 mm to about 5 mm.

Aspect 35: The decorative article of any one of aspects 1 to 34, wherein the core composition does not comprise a polyvinyl chloride.

Aspect 36: The decorative article of any one of aspects 1 to 35, wherein the core layer is a single extruded layer.

Aspect 37: The decorative article of any one of aspects 1 to 36, wherein the decorative portion comprises at least one of: polypropylene (PP), polyethylene (PE), polyethethylene terephthalate (PET), thermoplastic polyurethane (TPU), glycol-modified polyethylene terephthalate (PETG), polyurethane, polytrimethylene terephthalate (PTT), Nylon 6, or Nylon 6,6.

Aspect 38: The decorative article of any one of aspects 1 to 37, wherein the decorative portion comprises an image layer.

Aspect 39: The decorative article of aspect 38, wherein the image layer comprises a printed film layer.

Aspect 40: The decorative article of any one of aspects 1 to 39, wherein the decorative portion comprises a primer.

Aspect 41: The decorative article of any one of aspects to 40, wherein the decorative portion comprises a tie layer.

Aspect 42: The decorative article of aspect 39, wherein the printed film layer comprises an ink layer.

Aspect 43: The decorative article of aspect 42, wherein the ink layer comprises at least one ink selected from a water based, soy based, or solvent based ink.

Aspect 44: The decorative article of aspect 38, wherein the image layer comprises an ink layer printed directly upon the top surface of the core layer.

Aspect 45: The decorative article of any one of aspects 1 to 44, wherein the decorative article further comprises a tie layer.

Aspect 46: The decorative article of any one aspects 1 to 45, wherein the decorative article further comprises a wear layer.

Aspect 47: The decorative article of aspect 45, wherein the tie layer comprises at least one of: polyethylene terephthalate (PET), ethylene-vinyl acetate (EVA), polyurethane (PUR), polyethyleneimine (PEI), water bome extrusion coating primers, conventional acrylic materials, maleic anhydride (MAH), or ethylene-methyl acrylate (EMA).

Aspect 48: The decorative article of claim 45, wherein the tie layer comprises at least one of: ethylene-acrylic acid (EAA), ethylene methyl acrylate (EMA), ethylene-acrylic acid-maleic anhydride (EAAMAH), ethylene-methyl acrylate-maleic anhydride (EMAMAH), ethylene-vinyl acetate-maleic anhydride (EVAMAH), low density polyethylene-maleic anhydride (LDPEMAH), high density polyethylene-maleic anhydride (HDPE-MAH), polyurethane (PUR), polyurethane dispersion (PUD), or acrylic.

Aspect 49: The decorative article of any one of aspects 1 to 48, wherein the decorative article further comprises a scratch layer.

Aspect 50: The decorative article of aspect 49, wherein the scratch layer comprises at least one of corundum, emery, granite, quartz, aluminum oxide, silica, or trap rock, or a combination thereof.

Aspect 51: The decorative article of any one of aspects 1 to 50, wherein the decorative article further comprises a top layer.

Aspect 52: The decorative article of aspect 51, wherein the top layer is a scratch layer.

Aspect 53: The decorative article of any one of aspects 1 to 52, wherein the decorative article further comprises at least one of: an acoustic layer, a scrim layer, a fiberglass layer.

Aspect 54: The decorative article of aspect 46, wherein the wear layer comprises a UV stabilizer.

Aspect 55: The decorative article of any one of aspects 3 to 5 and 11-54, wherein the decorative article further comprises a balancing layer.

Aspect 56: The decorative article of any one of aspects 1, 6 to 8 or 10 to 55, wherein the balancing layer comprises at least one of: a non-woven material comprising polypropylene, a non-woven material comprising polyethylene terephthalate, a point bond material comprising polypropylene, a point bond material comprising polyethylene terephthalate, a film comprising polypropylene, a film comprising polyethylene, or UV cured lacquer.

Aspect 57: The decorative article of any one of aspects 1, 6 to 8, 10 to 35, or 37 to 57, wherein the balancing layer comprises polypropylene or polyethylene terephthalate and is co-extruded with the core layer.

Aspect 58: The decorative article of aspect 57, wherein the balancing layer comprises from greater than 0% to about 40% of the filler, from about 20% to about 50% of the first polyolefin, greater than 0% to about 15% of a stiffening polyolefin, and greater than 0% to about 10% of a compatibilizer.

Aspect 59: The decorative article of any one of aspects 56 to 57, wherein the balancing layer comprises UV lacquer.

Aspect 60: The decorative article of aspect 59, wherein the UV lacquer is acrylic resin.

Aspect 61: The decorative article of aspect 60, wherein the acrylic resin comprises at least one of: polyethylene terephthalate (PET), ethylene-vinyl acetate (EVA), polyurethane (PUR), polyethyleneimine (PEI), water borne extrusion coating primers, conventional acrylic materials, maleic anhydride (MAH), or ethylene-methyl acrylate (EMA).

Aspect 62: The decorative article of aspect 60, wherein the acrylic resin comprises at least one of ethylene-acrylic acid (EAA), ethylene methyl acrylate (EMA), ethylene-acrylic acid-maleic anhydride (EAAMAH), ethylene-methyl acrylate-maleic anhydride (EMAMAH), ethylene-vinyl acetate-maleic anhydride (EVAMAH), low density polyethylene-maleic anhydride (LDPEMAH), high density polyethylene-maleic anhydride (HDPE-MAH), polyurethane (PUR), polyurethane dispersion (PUD), or acrylic.

Aspect 63: The decorative article of aspect 58, wherein the stiffening polyolefin comprises polypropylene.

Aspect 64: The decorative article of aspect 63, wherein the polypropylene is a homopolymer.

Aspect 65: The decorative article of aspect 63 or 64, wherein the stiffening polyolefin has a melt mass-flow rate from about 10 g/10 min to about 18 g/10 min at 230° C./2.16 kg as determined by ASTM D1238.

Aspect 66: The decorative article of aspect 58, wherein the compatibilizer is a polypropylene grafted resin.

Aspect 67: The decorative article of aspect 58, wherein the compatibilizer is high density polyethylene grafted with maleic anhydride.

Aspect 68: The decorative article of any one of aspects 58, 66, or 67, wherein the compatibilizer has a melt mass-flow rate from about 415 g/10 min to about 445 g/10 min at 230° C./2.16 kg as determined by ASTM D1238.

Aspect 69: The decorative article of any one of aspects 58, 66, or 67, wherein the compatibilizer has a melt mass-flow rate from about 105 g/10 min to about 125 g/10 min at 190° C./2.16 kg as determined by ASTM D1238.

Aspect 70: The decorative article of aspect 67, wherein the maleic anhydride content is from about 1.3% to about 2.0% by weight of the compatibilizer.

Aspect 71: A method of making a decorative article comprising: a, providing a core layer from a core composition comprising a first polyolefin and a filler, wherein the formed core layer has a top surface and an opposing bottom surface; and b, attaching a decorative portion having a top surface and an opposing bottom surface to the top surface of the core layer.

Aspect 72: The method of aspect 71, wherein the bottom surface of the decorative portion is attached to the top surface of the core layer using a tie layer.

Aspect 73: The method of aspect 71 or 72, wherein the first polyolefin is a polypropylene elastomer comprising from greater than 10 to 15 weight percent ethylene derived units based upon the weight of the polypropylene elastomer

Aspect 74: The method of any one of aspects 71-73, wherein the core composition further comprises a stiffening polyolefin.

Aspect 75: The method of any one of aspects 71-74, wherein the core composition further comprises a compatibilizer.

Aspect 76: The method of any one of aspects 71-76, wherein the opposing bottom surface of the core layer is attached to a top surface of a balancing layer.

1. A decorative article comprising:
a balancing layer having a top surface and an opposing bottom surface;
a core layer having a top surface and an opposing bottom surface, wherein the decorative article comprises only one core layer being a single layer, wherein the core layer comprises a core composition comprising a first polyolefin and a filler, wherein the top surface of the balancing layer is attached to the bottom surface of the core layer; and
a decorative portion having a top surface and an opposing bottom surface, wherein the top surface of the core layer is attached to the bottom surface of the decorative portion,
wherein the decorative article has a flexibility-drape distance of from about 0.5″ to about 8″ as measured by a Drape Test at a length of 12″,
wherein the core composition further comprises a stiffening polyolefin,
wherein the core composition comprises from greater than 0% by weight to about 15% by weight of the stiffening polyolefin.

2. (canceled)

3. (canceled)

4. (canceled)

5. (canceled)

6. (canceled)

7. (canceled)

8. (canceled)

9. (canceled)

10. (canceled)

11. The decorative article of claim 1, wherein the first polyolefin is an elastomer of propylene and ethylene derived units.

12. The decorative article of claim 11, wherein the elastomer is a polypropylene elastomer comprising from greater than 10 to 15 weight percent ethylene derived units based upon the weight of the polypropylene elastomer.

13. (canceled)

14. (canceled)

15. The decorative article of claim 1, wherein the filler comprises calcium carbonate, fly-ash, recycled calcium carbonate, aluminum trihydrate, talc, nano-clay, barium sulfate, barite, barite glass fiber, glass powder, glass cullet, metal powder, alumina, hydrated alumina, clay, magnesium carbonate, calcium sulfate, silica, glass, fumed silica, carbon black, graphite, cement dust, feldspar, nepheline, magnesium oxide, zinc oxide, aluminum silicate, calcium silicate, titanium dioxide, titanates, glass microspheres, chalk, calcium oxide, or any combination thereof.

16. (canceled)

17. (canceled)

18. The decorative article of claim 1, wherein the stiffening polyolefin comprises polypropylene.

19. (canceled)

20. (canceled)

21. The decorative article of claim 1, wherein the core composition further comprises a compatibilizer.

22. The decorative article of claim 21, wherein the compatibilizer is a polypropylene grafted resin.

23. The decorative article of claim 21, wherein the compatibilizer is high density polyethylene grafted with maleic anhydride.

24. (canceled)

25. (canceled)

26. The decorative article of claim 23, wherein the maleic anhydride content is from about 0.3% to about 2.5% by weight of the compatibilizer.

27. The decorative article of claim 1, wherein the core composition comprises from about 45% to about 95% by weight of the filler.

28. (canceled)

29. The decorative article of claim 1, wherein the core composition comprises from about 10% to about 30% by weight of the first polyolefin.

30. (canceled)

31. The decorative article of claim 21, wherein the core composition comprises from greater than 0% by weight to about 10% by weight of the compatibilizer.

32. The decorative article of claim 1, wherein the core composition comprises from about 10% to about 30% by weight of the first polyolefin, from greater than 0% by weight to about 15% by weight of the stiffening polyolefin, and from greater than 0% by weight to about 10% by weight of a compatibilizer.

33. (canceled)

34. (canceled)

35. (canceled)

36. (canceled)

37. (canceled)

38. The decorative article of claim 1, wherein the decorative portion comprises an image layer.

39. (canceled)

40. The decorative article of claim 1, wherein the decorative portion comprises a primer.

41. (canceled)

42. (canceled)

43. (canceled)

44. The decorative article of claim 38, wherein the image layer comprises an image printed directly upon the top surface of the core layer.

45. The decorative article of claim 1, wherein the decorative article further comprises a tie layer.

46. The decorative article of claim 1, wherein the decorative article further comprises a wear layer.

47. (canceled)

48. (canceled)

49. The decorative article of claim 1, wherein the decorative article further comprises a scratch layer.

50. (canceled)

51. (canceled)

52. (canceled)

53. (canceled)

54. (canceled)

55. A decorative article comprising:
a balancing layer having a top surface and an opposing bottom surface;
a core layer having a top surface and an opposing bottom surface, wherein the decorative article comprises only one core layer being a single layer, wherein the core layer comprises a core composition comprising a first polyolefin and a filler, wherein the top surface of the balancing layer is attached to the opposing bottom surface of the core layer; and
a decorative portion having a top surface and an opposing bottom surface, wherein the top surface of the core layer is attached to the opposing bottom surface of the decorative portion,
wherein the decorative article has a flexibility-drape distance of from about 0.5″ to about 8″ as measured by a Drape Test at a length of 12″,
wherein the balancing layer comprises polypropylene or polyethylene terephthalate and is co-extruded with the core layer,
wherein the balancing layer comprises from greater than 0% to about 40% of the filler, from about 20% to about 50% of the first polyolefin, greater than 0% to about 15% of a stiffening polyolefin, and greater than 0% to about 10% of a compatibilizer.

56. The decorative article of claim 55, wherein the balancing layer comprises at least one of: a non-woven material comprising polypropylene, a non-woven material comprising polyethylene terephthalate, a point bond material comprising polypropylene, a point bond material comprising polyethylene terephthalate, a film comprising polypropylene, a film comprising polyethylene, or UV cured lacquer.

57. (canceled)

58. (canceled)

59. (canceled)

60. (canceled)

61. (canceled)

62. (canceled)

63. The decorative article of claim 55, wherein the stiffening polyolefin comprises polypropylene.

64. (canceled)

65. (canceled)

66. (canceled)

67. The decorative article of claim 55, wherein the compatibilizer is high density polyethylene grafted with maleic anhydride.

68. (canceled)

69. (canceled)

70. (canceled)

71. A method of making a decorative article comprising:
a. providing a core layer from a core composition comprising a first polyolefin and a filler, wherein the core layer has a top surface and an opposing bottom surface; and
b. attaching a decorative portion having a top surface and an opposing bottom surface to the top surface of the core layer,
wherein the first polyolefin is a polypropylene elastomer comprising from greater than 10 to 15 weight percent ethylene derived units based upon the weight of the polypropylene elastomer.

72. (canceled)

73. (canceled)

74. (canceled)

75. (canceled)

76. The method of claim 71, wherein the opposing bottom surface of the core layer is attached to a top surface of a balancing layer.
